(19) United States
(12) Patent Application Publication
(10) Pub. No.: US 2017/0161855 A1
(43) Pub. Date: Jun. 8, 2017

(54) OPTIMIZED SMALL SCREEN DEVICE TO DISPLAY VISUAL ELEMENTS IN A REAL PROPERTY DASHBOARD INVOLVING PREDICTIVE ANALYTICS

(71) Applicant: C2C Solutions, Inc., Chicago, IL (US)

(72) Inventor: Lauren Schreyer, CHICAGO, IL (US)

(21) Appl. No.: 14/962,458

(22) Filed: Dec. 8, 2015

(51) Int. Cl. G06Q 50/16; G06Q 10/06; G06F 3/0482

(52) U.S. Cl. CPC G06Q 50/167; G06F 3/0482; G06Q 10/06316

(57) ABSTRACT

Systems and methods are provided for configuring a mobile device with a limited size screen to optimize visual output created and managed with a workflow management engine using predictive analytics techniques. The workflow management engine may use historical workflow data to generate predictive models, and may include a recommendation engine to make adjustments to a default workflow based on the predictive models. The workflow management engine may also include a workflow execution engine to execute one or more phases associated with the adjusted workflow, and generate notifications based on one or more factors.

### BACKGROUND

A real estate transaction typically involves multiple parties, multiple systems, complex administrative processes, and the exchange of several critical pieces of information. Buyers may not have familiarity with these complex administrative processes and may not know where to find critical information relating to property transactions. Further, systems may experience delays in accessing and reconciling information collected from various parties and other systems. These issues may cause delays between the time a property is contracted and closed, and often even cause a real estate transaction to fall through due to inefficiencies.

In addition, numerous real estate jurisdictions have recently changed the process of borrowing to buy a home. This new integrated disclosure rule (TRID) impacts how real estate brokers will manage their clients from the initial offer for a home until the closing of the transaction. TRID requires brokers, buyers, seller, and all parties to the transaction to jump through additional hoops and meet specific timeline requirements before closing a real estate transaction. For example, TRID created a new “loan estimate” form that replaces the previous truth-in-lending and good faith estimates forms, and this new form must be delivered to consumers within three business days of their application for a loan. In addition a new closing disclosure form replaces the prior HUD-1 form, and it must be received by consumers no later than three business days prior to the loan consummation, which likely would fall on the closing date. Such timing and process requirements means that the risk of a due date or requirement being missed, thus the entire transaction being possibly delayed, is increased.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

An illustrative example described herein provides a computer-assisted method of optimizing a workflow using predictive analytics techniques. A workflow management engine may receive a request to create a new workflow from a smartphone associated with a buyer via a dashboard. In response to the request, an initiation module of the workflow management engine may create buyer profile, where the buyer profile includes buyer attributes associated with the buyer. Further, the initiation module may create a property profile, where the property profile includes property attributes associated with the property. The workflow management engine may generate a default workflow for the buyer, where the default workflow may include a first set of phases, and where the first set of phases may be associated with a first set of deadlines. A recommendation engine of the workflow management engine may then construct predictive models including data points representing previous workflow managed by the workflow management engine. The data points may include buyer attributes, property attributes, and status attributes attributed to some or all of the previous workflows. Based on the predictive models, the recommendation engine may generate rules, where the rules may include mappings between a label and buyer attributes, property attributes, and status attributes. The recommendation engine may then generate an adjusted workflow for the buyer by adjusting the default workflow based on the rules. The adjusted workflow may have a higher likelihood of success than the default workflow. The adjusted workflow may include a second set of phases, and the phases may be associated with a second set of deadlines.

Additional aspects of the present disclosure will be apparent in view of the detailed description provided below.

### BRIEF DESCRIPTION OF THE DRAWINGS

Aspects of the disclosure may be implemented in certain parts, steps, and embodiments that will be described in detail in the following description and illustrated in the accompanying drawings in which like reference numerals indicate similar elements. It will be appreciated with the benefit of this disclosure that the steps illustrated in the accompanying figures may be performed in other than the recited order and that one or more of the steps disclosed may be optional. It will also be appreciated with the benefit of this disclosure that one or more components illustrated in the accompanying figures may be positioned in other than the disclosed arrangement and that one or more of the components illustrated may be optional.

FIG. 1 is a block diagram of an illustrated networked computing system including an example real estate workflow management engine in accordance with one or more aspects described herein.

FIG. 2 is a block diagram of an illustrative implementation of a real estate workflow management engine in accordance with one or more aspects described herein.

FIG. 3 is a flowchart of an illustrative method for initiating a new real estate transaction via the contract-to-close dashboard in accordance with one or more aspects described herein.

FIG. 4 is a block diagram of an illustrative implementation of a recommendation engine of a real estate workflow management engine to provide predictive analytics in accordance with one or more aspects described herein.

FIG. 5 is a flowchart of an illustrative contract-to-close workflow in accordance with one or more aspects described herein.

FIG. 6 is an example user interface for the Getting Started screen of the contract-to-close dashboard in accordance with one or more aspects described herein.

FIG. 7 is an example user interface for the Dashboard screen of the contract-to-close dashboard in accordance with one or more aspects described herein.

FIG. 8 is an example user interface of the Your Profile screen of the contract-to-close dashboard in accordance with one or more aspects described herein.

FIG. 9 is an example user interface of the Property screen of the contract-to-close dashboard in accordance with one or more aspects described herein.

FIG. 10 is an example user interface of the Mortgage screen of the contract-to-close dashboard in accordance with one or more aspects described herein.

FIG. 11 is an example user interface of the Inspection screen of the contract-to-close dashboard in accordance with one or more aspects described herein.

FIG. 12 is an example user interface of the Attorney Review screen of the contract-to-close dashboard in accordance with one or more aspects described herein.

FIG. 13 is an example user interface of the Insurance screen of the contract-to-close dashboard in accordance with one or more aspects described herein.

FIG. 14 is an example user interface of the Title screen of the contract-to-close dashboard in accordance with one or more aspects described herein.

FIG. 15 is an example user interface of the Closing screen of the contract-to-close dashboard in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

Various aspects described herein may involve a method, a computer system, and/or a computer program product. Accordingly, some aspects may take the form of an entirely hardware embodiment, or an embodiment combining software and hardware aspects. Furthermore, such aspects may take the form of a computer program stored by one or more non-transitory computer-readable storage media having computer-readable program code, or instructions, embodied in or on the storage media. Any suitable non-transitory computer readable storage media may be utilized, including hard disks, CD-ROMs, optical storage devices, magnetic storage devices, and/or any combination thereof.

It is noted that various connections between elements are discussed in the following description. It is noted that these connections are general and, unless specified otherwise, may be direct or indirect, wired or wireless, and that the specification is not intended to be limiting in this respect. As such, various signals representing data or events as described herein may be transferred between a source and a destination in a form of electromagnetic waves traveling through signal-conducting media such as metal wires, optical fibers, and/or wireless transmission (e.g., air and/or space) such that the source and destination are in signal communication with each other.

Moreover, it is to be understood that the phraseology and terminology use herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof, as well as additional items and equivalents thereof.

As discussed herein, a real estate transaction may involve multiple parties (e.g., one or more buyers, one or more sellers, one or more attorneys, one or more banks, one or more inspectors, one or more insurance companies, one or more title companies, etc.). Further, a real estate transaction may involve multiple processes and/or systems for gathering information from the multiple parties. In some examples, the multiple processes and/or systems may specify deadlines (i.e., dates by which a process must be completed). Accordingly, the devices, systems, and methods described herein may be related to systems and methods of creating a contract-to-close workflow using predictive analytics techniques for managing a real estate transaction involving multiple parties.

Aspects of the present disclosure are directed toward a real estate workflow management engine, where the real estate workflow management engine is configured to provide a seamless process from a property being under contract (i.e., the seller has accepted an offer from the buyer) to the closing (i.e., the ownership of the property is transferred from the property sellers to the buyer). In some examples, the real estate workflow management engine may define one or more phases, such that each phase must be completed in order to successfully complete a real estate transaction. The one or more phases may be executed in parallel or sequentially. In some cases, one or more phases may have prerequisites. For instance, a phase may be defined to require commencement or completion of another phase. Alternatively, a phase may be defined to require a partial completion of another phase (e.g., the insurance phase can be commenced so long as at least 50% of the attorney review phase has been completed, etc.). Further, the one or more phases may be executed synchronously or asynchronously by the parties associated with the real estate transaction. In some examples, the phases may include an initiation phase (e.g., to define buyer profile and property profile), a mortgage phase, an inspection phase, an attorney review phase, an insurance phase, a title phase, and a closing phase. Some or all of the aspects of the systems and arrangements described herein may be performed automatically, as will be discussed below.

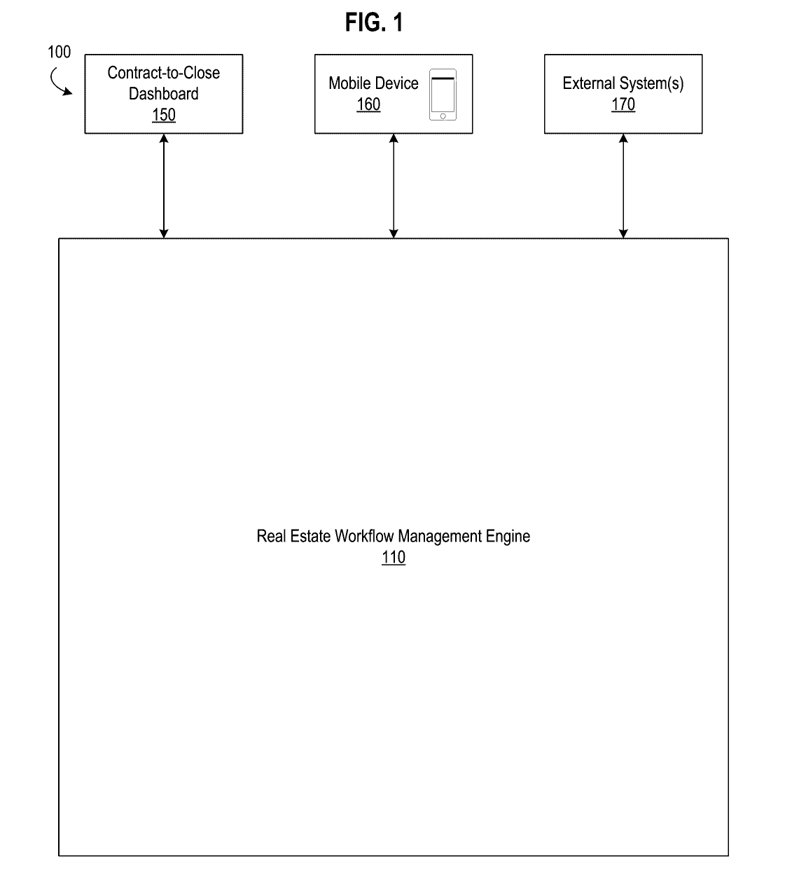

FIG. 1 shows an illustrative networked computing system 100 (e.g., a real estate workflow management system). The real estate workflow management system 100 may include a real estate workflow management engine 110, and may be configured to communicate with a contract-to-close dashboard 120, a mobile device 130, and one or more external systems 140 (e.g., credit reporting agencies, banks, credit card providers, insurance companies, analytics companies, etc.), according to one or more aspects of the present disclosure. The real estate workflow management engine 110, described in further detail below, may acquire and maintain data related to a real estate transaction, generate a contract-to-close workflow, adjust the contract-to-close workflow based on one or more factors, and generate notifications based on one or more factors.

The contract-to-close dashboard 150 may provide an interface for the parties associated with the real estate transaction to provide an receive some or all data relating to the real estate transaction. The interface may be, for example, a web browser, a desktop application, a mobile application, or the like that resides at a computing device. The contract-to-close dashboard 150 may be in signal communication with the real estate workflow management engine 110 via a network. The network may include one or more of a wired network (e.g., the Internet), a wireless network (e.g., a cellular network, Bluetooth, NFC), or a combination of wired or wireless networks.

Additionally or alternatively, an interface may reside on a mobile device 130. The mobile device 130 may be, for example, a mobile phone, a personal digital assistant (PDA), a wearable device, or a tablet computer of one of the parties associated with the real estate transaction. Software applications executing on the mobile device 130 may be configured to communicate with the real estate workflow management engine 110 to provide or receive some or all data relating to the real estate transaction. In some examples, the mobile device 130 may communicate with the real estate workflow management engine 110 via a mobile browser installed on the mobile device 130. In other examples, the mobile device 130 may communicate with the real estate workflow management engine 110 via a real estate workflow management engine mobile application (e.g., an iOS application, an Android application, etc.) installed on the mobile device 130. The mobile device 130 may be in signal communication with the real estate workflow management engine 110 via a network such as those described above. As such, the mobile device 130 may include an antenna configured for communication with the real estate workflow management engine 110. In some examples, the mobile device 130 may be equipped with a GPS receiver (e.g., any hardware configured to provide location detection functionality, such as GPS functionality) to determine its location, an accelerometer, an antenna for communication, a camera.

In some examples, the real estate workflow management engine 110 may acquire information related to the real estate transaction from one or more external systems 140. For example, the real estate workflow management engine 110 may acquire a credit report for a buyer from one or more credit reporting agencies, purchasing history for a buyer from one or more banks and/or one or more credit card providers, purchasing history, tax records, and police records for a property from a county assessor's office, insurance claim history from one or more insurance providers, legal history from one or more government agencies, and/or consumer analytics from one or more data analytics companies. It will be appreciated the real estate workflow management engine 110 may acquire information from additional or alternative external systems 140.

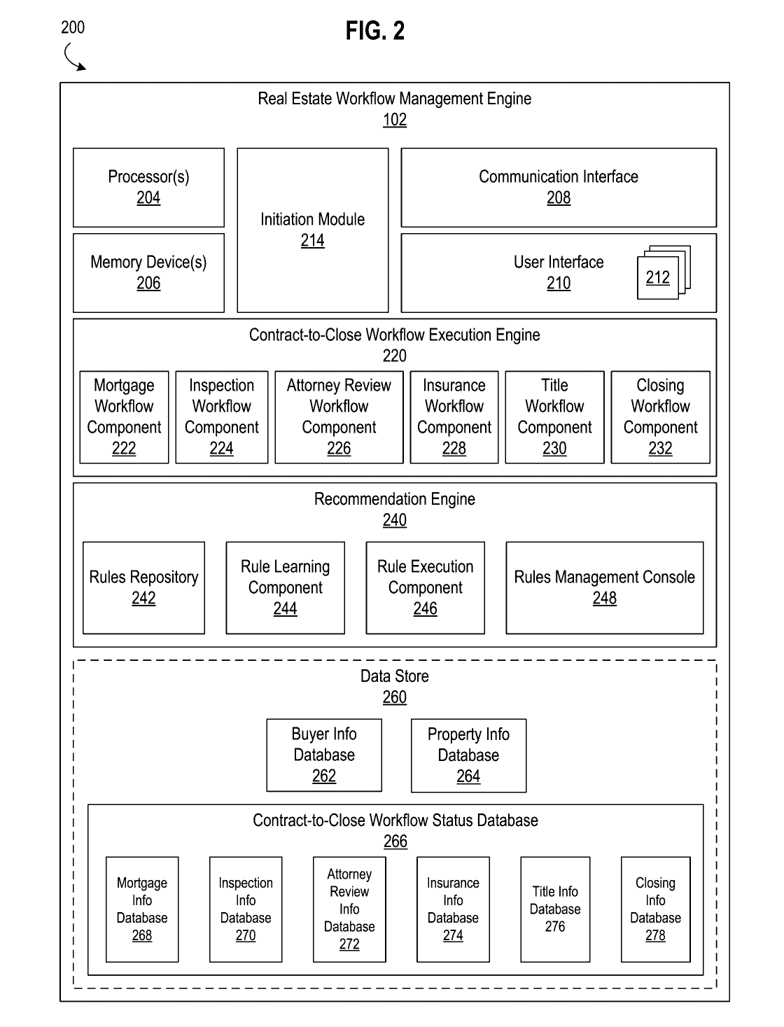

FIG. 2 shows an example real estate workflow management engine 110. The real estate workflow management engine 110 may include various components, modules, and sub-modules that facilitate various tasks, including acquiring and maintaining data related to a real estate transaction, generating a contract-to-close workflow, adjusting the contract-to-close workflow based on one or more factors, and generating notifications based on one or more factors. It will be appreciated that the real estate workflow management engine 110 illustrated in FIG. 2 is shown by way of example and that other implementations of a real estate workflow management engine 110 may include additional or alternative components, modules, sub-systems, and so forth. In this example, the real estate workflow management engine includes one or more processors 204, one or more memory devices 206, a communication interface 208, a user interface 210, an initiation module 214, a contract-to-close workflow execution engine 220, a recommendation engine 240, and a data store 260. Also, in this example, the contract-to-close workflow execution engine 220 includes a mortgage workflow component 222, an inspection workflow component 224, an attorney review workflow component 226, an insurance workflow component 228, a title workflow component 230, and a closing workflow component 232. Further, in this example, the recommendation engine 240 includes a rules repository 242, a rule learning component 244, a rule execution component 246, and a rules management console 248. The real estate workflow management engine 110 may be implemented using a special purpose computing device (or computing devices) that have been specially programmed to perform functionality according to one or more aspects of the present disclosure.

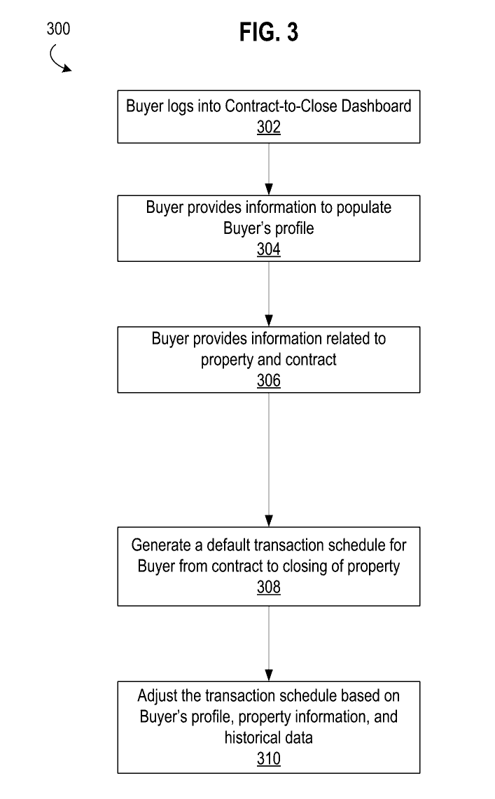

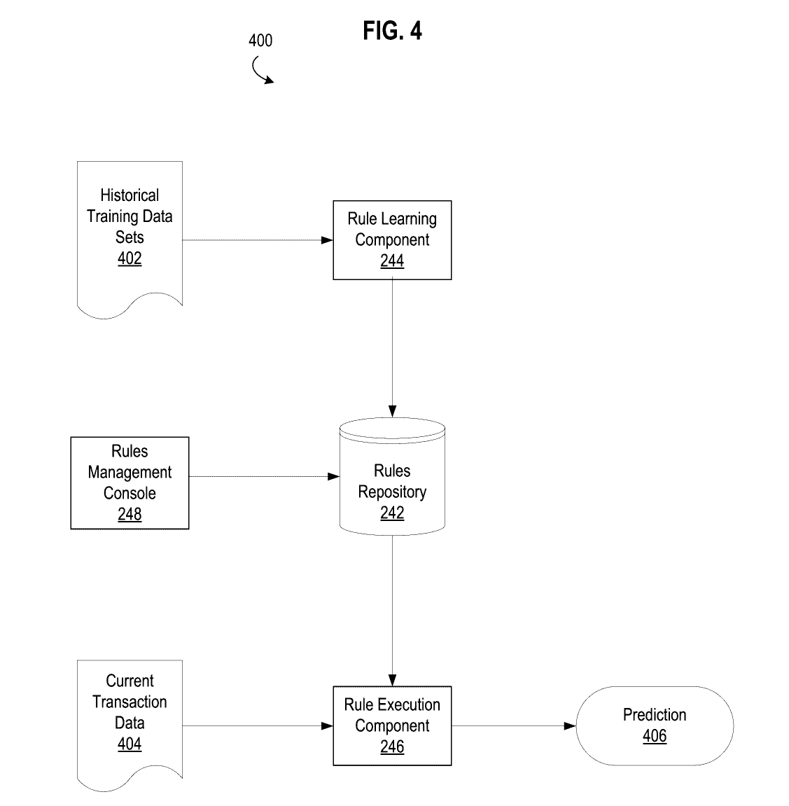

The one or more processors 204 (e.g., microprocessor, microcontroller, etc.) of the real estate workflow management engine 110 may operate by using an algorithm that facilitates acquiring and maintaining data related to real estate transactions, generating contract-to-close workflows, adjusting contract-to-close workflows based on one or more factors, and generating notifications based on one or more factors. This algorithm may be included as instructions stored in the one or more memory devices 206 and may be included as a portion of the initiation module 214, the contract-to-close workflow execution engine 220, and/or the recommendation engine 240. The one or more processors 204, for example, may operate by receiving and delivering information from the contract-to-close dashboard and/or the mobile device 130. In another example, the one or more processors 204 may operate by receiving information from the one or more external systems 140. An illustrative algorithm will be described below with reference to FIGS. 3 and 4.

In this example, the one or more processors 204 may be configured to operate the algorithm, the initiation module 214, the contract-to-close workflow execution engine 220, and/or the recommendation engine 240 using an operating system (e.g., Windows, Linux, Unix, GNU, OS X, iOS, Android, etc.). In some cases, the one or more memory devices 206 may be communicatively coupled to the one or more processors 204, such as via a data bus. The one or more memory devices 206 may be used to store any desired information, such as the aforementioned algorithm, a lookup table, computer-executable instructions to implement the business rules for enabling a seamless real estate workflow, and/or the like. The one or more memory devices 206 may be any suitable type of storage, including, but not limited to, RAM, ROM, EPROM, flash memory, a hard drive, etc. In some examples, the one or more processors 204 may store information within and/or may retrieve information from the one or more memory devices 206.

The communication interface 208 of the real estate workflow management engine 110 may facilitate communication between the real estate workflow management engine 110, the contract-to-close dashboard 120, the mobile device 130, and/or the one or more external systems 140 via a network using one or more wired or wireless communication links. In some examples, the real estate workflow management engine 110 may include one or more computing devices that may be communicatively coupled to a network. The network may be communicatively coupled to one or more devices, such as to servers associated with the contract-to-close dashboard 150 and/or the one or more external systems 140. The network may include one or more wired and/or wireless networks, such as a telecommunications network (e.gl, a cellular network, a land line network, a cable network, etc.), a Wi-Fi network, a local area network (LAN), a wide area network (WAN), the Internet, etc. When used in a LAN networking environment, the real estate workflow management engine 110 may include a modem and/or other means for establishing wired and/or wireless communication over the WAN, such as the Internet. It will be appreciated that the network connections discussed herein are illustrative and other means of establishing communications links between the real estate workflow management engine 110, the contract-to-close dashboard 120, the mobile device 130, and/or the one or more external systems 140 may include one or more various protocols such as TCP/IP, Ethernet, FTP, HTTP, etc.

The data store 260 (e.g., a database) of the real estate workflow management engine 110 may be used to store information related to real estate transactions. For example, the data store 260 may be used to store information related to the one or more buyers, one or more sellers, the property associated with a real estate transaction. Further, the data store 260 may be used to store information related to the current status of the real estate transaction as it goes through the contract-to-close workflow. In some examples, the data store 260 may include a buyer info database 262, a property info database 264, and a contract-to-close workflow status database 266. The contract-to-close workflow execution engine 220 may utilize these databases to maintain data relating to real estate transactions, generate contract-to-close workflows, adjust contract-to-close workflows based on one or more factors, and generate notifications based on one or more factors.

The buyer info database 262 may store information associated with the one or more buyers associated with a real estate transaction, e.g., name of buyer, age of buyer, image of buyer, contact information, social security number, credit status, marital status, educational background, employment history (job stability, recent loss of employment, etc.), etc. Further, the buyer info database 262 may store authentication information for the buyer (e.g., username, password, etc.), in order to authenticate the buyer's access via the contract-to-close dashboard 120. In some examples, the buyer info database 262 may also store information associated with the one or more parties associated with the buyer. For instance, the buyer info database 262 may store information associated with a buyer's lawyer, mortgage broker, real estate agent, and/or other contacts (e.g., co-buyers, spouse, etc.). As such, the buyer info database 262 may also store authentication information for the one or more parties associated with the buyer. In some examples, the authentication information for some or all of the one or more parties may be identical to the authentication information for the buyer. In other examples, the authentication information for some or all of the one or more parties may be different from the authentication information for the buyer. In these examples, the real estate workflow management engine 110 may advantageously display information based on the authentication information provided. For instance, the real estate workflow management engine 110 may be configured such that only the buyer is able to view and/or edit the buyer's profile information (e.g., contact information, social security number, user preferences, etc.). It will be appreciated that one or more of these fields may be designed as mandatory or optional in some example implementations of a real estate workflow management engine 110.

The property info database 264 may store information associated with a property associated with a real estate transaction, e.g., a Property Identification Number (PIN) number, address of property, image of property, contract acceptance date, purchase price, loan amount, etc. In some examples, the property info database 264 may also store one or more buyers associated with the property info database 264. As such, the property info database 264 may maintain, e.g., through a database relationship, an association between a property in the property info database 264 and one or more buyers in the buyer info database 262. It will be appreciated that one or more of these fields may be designed as mandatory or optional in some example implementations of a real estate workflow management engine 110.

The contract-to-close workflow status database 266 may store information associated with the status of each phase of the real estate transaction. In some examples, the contract-to-close workflow status database 266 may include a separate database (or table(s)) to store information related to a particular phase. For instance, the contract-to-close workflow status database 266 may include a mortgage info database 268, an inspection info database 270, an attorney review info database 272, an insurance info database 274, a title info database 276, and a closing info database 278. In some example, the contract-to-close workflow status database 266, and/or each of the databases included in the contract-to-close workflow status database 266 (268-278), may maintain, e.g., through a database relationship, an association between one or more workflow statuses, a property in the property info database 264, and one or more buyers in the buyer info database 262.

The mortgage info database 268 may store information related to the process of acquiring a mortgage and/or loan on the property, e.g., a mortgage contingency due date, an indicator for whether mortgage or loan application has been signed and an associated date, an indicator for whether mortgage or loan application has been sent and an associate date, an indicator for whether a loan estimate has been received, an indicated for whether buyer has approved and sent back the loan estimate and an associated date, an indicator for whether the buyer has sent a copy of the purchase contract to the loan officer and an associated date, an indicator for whether the buyer has wired funds to the title company, an interest rate, an indicated for whether the buyer has locked the interest rate, a term of loan (e.g., 5/1, 7/1, 10/1, 15-year fixed, 30-year fixed, etc.), a payment amount, HOA fees, taxes, an indicator for whether the buyer's bank is escrowing and paying the taxes, an insurance amount, an indicator for whether the buyer's bank is escrowing and paying the insurance amount, a total monthly payment, etc. In some instances, the mortgage info database 268 may store additional information related to payments, e.g., a total purchase price, an initial earnest amount, a source of funds for the initial earnest amount, a balance of earnest amount, a total loan amount, and a source of funds for the total loan amount. The mortgage info database 268 may also store derived information (e.g., calculated based on a formula). For instance, the mortgage info database 268 may store a balance remaining to purchase, which may be calculated, for example, by subtracting the initial earnest amount and the balance of earnest amount from the total purchase price. Further, the mortgage info database 268 may store a balance needed to close and a source of funds for the balance needed to close, which may be calculated, for example, by subtracting a total loan amount from the balance remaining to purchase. It will be appreciated that one or more of these fields may be designed as mandatory or optional in some example implementations of a real estate workflow management engine 110.

The inspection info database 270 may store information related to the process of obtaining an inspection of the property, e.g., an inspection completion date, an inspection period (e.g., a number of business days, etc.), an inspection company, an inspector name, contact information for the inspector, an indicator for whether the inspection report was delivered and an associated date, an indicator for whether the inspection report was sent to the attorney and an associated date, etc. It will be appreciated that one or more of these fields may be designed as mandatory or optional in some example implementations of a real estate workflow management engine 110.

The attorney review info database 272 may store information related to the process of obtaining an attorney review, e.g., an attorney review date, an attorney review period (e.g., a number of business days, etc.), an attorney name, contact information for the attorney, an indicator for whether the attorney has agreed and signed to the terms of deal and an associated date, etc. It will be appreciated that one or more of these fields may be designed as mandatory or optional in some example implementations of a real estate workflow management engine 110.

The insurance info database 274 may store information related to the process of obtaining insurance coverage, e.g., an insurance company, a coverage type, an indicator for whether the coverage type conforms to one or more standards, an insurance agent name, contact information for the insurance agent, an insurance policy number, etc. It will be appreciated that one or more of these fields may be designed as mandatory or optional in some example implementations of a real estate workflow management engine 110.

The title info database 276 may store information related to obtaining title to the property, e.g., a title company, a location of the title company, a closer of the title company, contact information for the closer and/or title company, payment methods (e.g., wiring instructions), an earnest money amount, etc. It will be appreciated that one or more of these fields may be designed as mandatory or optional in some example implementations of a real estate workflow management engine 110.

The closing info database 278 may store information related to closing the property, e.g., an indicator for whether the buyer has received a closing disclosure and an associated date, an indicator for whether the buyer has signed the closing disclosure and an associated date, an indicated for whether the buyer has sent the closing disclosure and associated date, an indicator for whether the buyer has scheduled the closing and an associated scheduled closing date, a confirmed closing date, a title company, contact information for the title company, payment methods (e.g., wiring instructions), a swift code for international transactions, etc. It will be appreciated that the information related to the title company may be obtained from the title info database 276, or may be maintained separately in the closing info database 278 once the title phase of the real estate transaction has been completed. It will be appreciated that one or more of these fields may be designed as mandatory or optional in some example implementations of a real estate workflow management engine 110.

Additionally, in some cases, the data store 260 may be used to store computer-executable instructions to cause a computer device (e.g., the initiation module 214, the contract-to-close workflow execution engine 220, the recommendation engine 240, etc.) to facilitate acquiring and maintaining data related to real estate transactions, generating contract-to-close workflows, adjusting contract-to-close workflows based on one or more factors, and generating notifications based on one or more factors.

In some embodiments, the real estate workflow management engine 110 may include other inputs and/or outputs (I/O). The I/O may include a data port (e.g., a wireless port) that may be configured for communication using a protocol, such as a Bluetooth™, Wi-Fi 33, Zigbee, or any other wireless protocol. In other case, the data port may be a wired port such as a serial port, an ARCNET port, a parallel port, a serial port, a CAT5 port, a Universal Serial Bus (USB) port, etc. In some cases, the data port of the I/O may use one or more communication protocols, such as Ethernet, etc., that may be used via a wired network or a wireless network. In some instances, the I/O may include a USB port and may be used to download and/or upload information from a USB flash drive or some other data source. Other remote devices may also be used.

The I/O may be configured to communicate with the one or more processors 204 and may, if desired, be used to upload information for use by the one or more processors 204 and/or download information from the one or more processors 204. In some cases, the I/O may be used to download data stored within the one or more memory devices 206 and/or the data store 260. For instance, the I/O may be used to download buyer info, property info, information relating to the current status of a real estate transaction, etc. In such examples, the data may be downloaded to a device such as a USB drive, a personal computer, a tablet computer, a PDA, a smart phone, or other device. In some cases, the data may be optionally convertible to a different format or presentation (e.g., a spreadsheet, a text document, a plain text file, an XML file, a published document, etc.) from the format maintained within the memory devices 206 and/or the data store 260 to aid interpretability.

The user interface 210 of the real estate workflow management engine 110 may be a user interface device that permits the real estate workflow management engine 110 to display information and/or solicit information, as well as accept one or more user interactions with a user. For example, the user interface 210 may permit a user to initiate a new real estate transaction by providing buyer profile information and/or property profile information. In other examples, the user interface 210 may permit the user to view and/or edit information associated with one or more phases of a real estate workflow. In some cases, the user interface 210 may include a display and a distinct keypad. In some cases, the user interface 210 may include a display and a virtual keypad. A display may be any suitable display. In some instances, the display may include or may be a liquid crystal display (LCD), and in some cases a fixed segment display or a dot matrix LCD display. In other instances, the display may be a touch screen LCD panel that functions both as a display and as a keypad. In such cases, the touch screen LCD panel may be adapted to solicit information from a user and/or receive such information.

The user interface 210 may be adapted to display one or more user interface screens 212. For example, the real estate workflow management engine 110 may be configured to solicit and/or present information to a buyer via the one or more user interface screens 212, such as displaying and/or soliciting buyer profile information, displaying and/or soliciting property information, displaying and/or soliciting real estate workflow status information, etc.

In some cases, the user interface screens 212 may be provided to the contract-to-close dashboard 120. In such examples, the contract-to-close dashboard may also include methods for inputs and/or outputs, as described above.

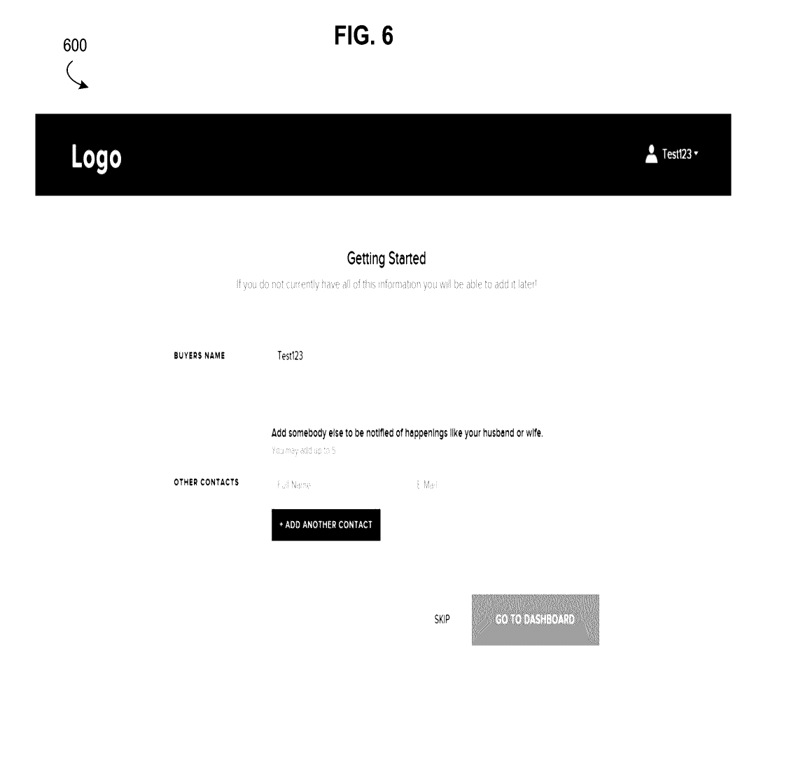

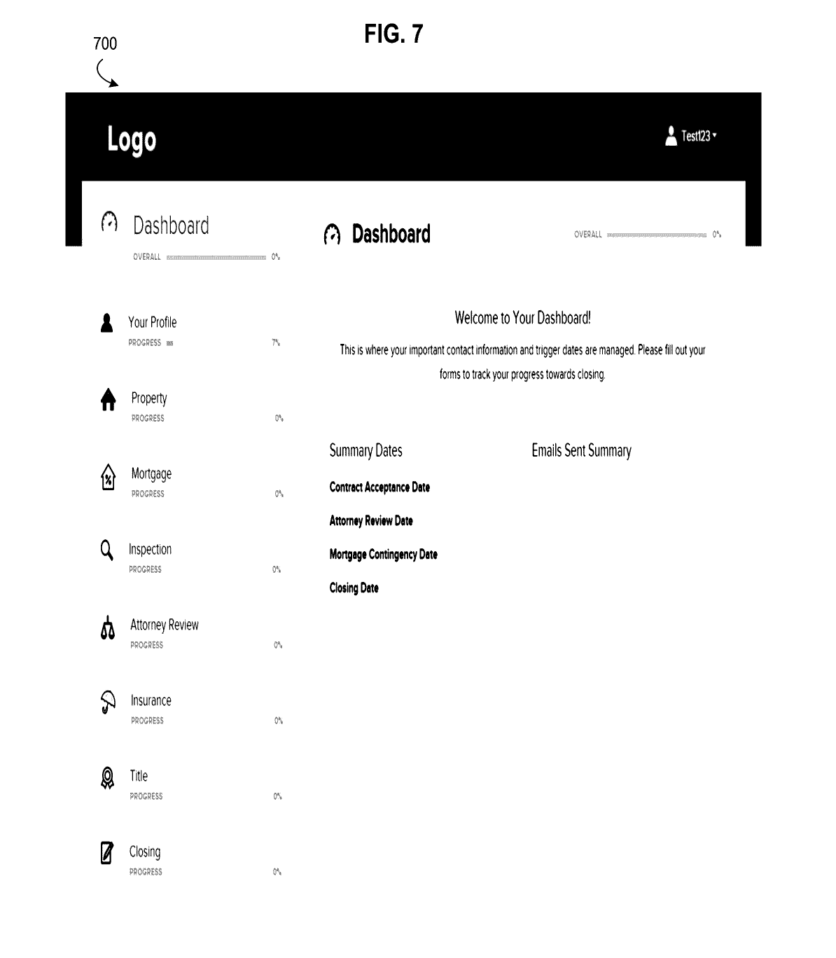

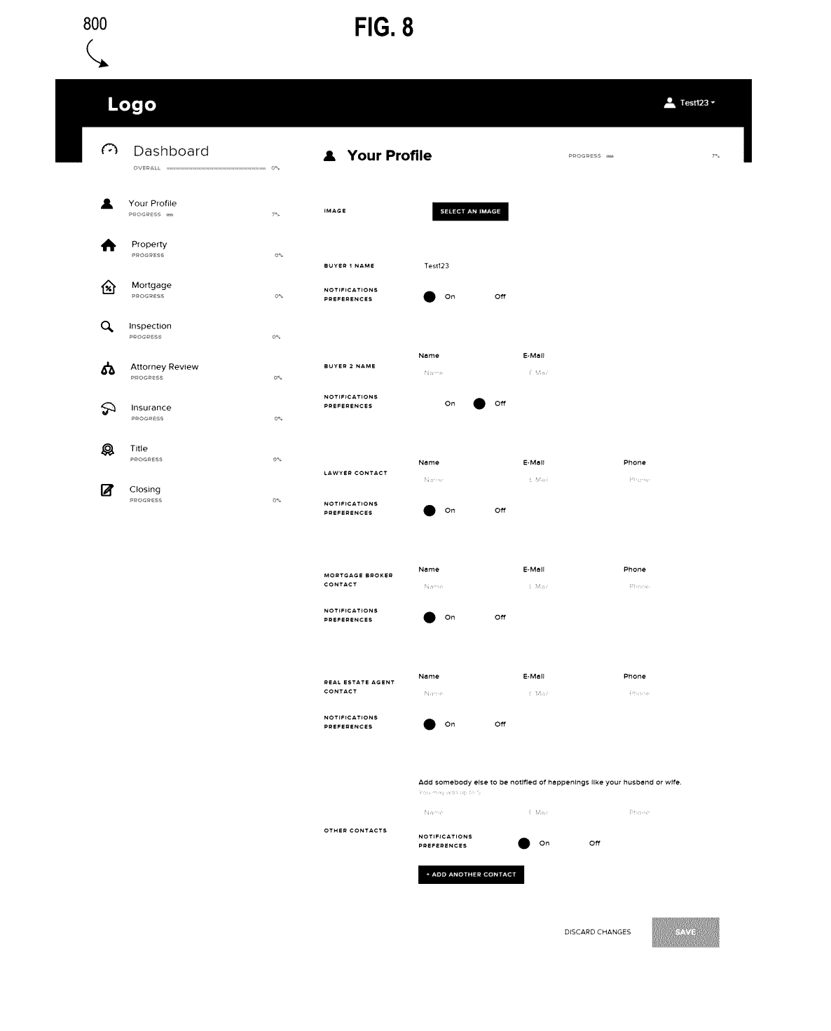

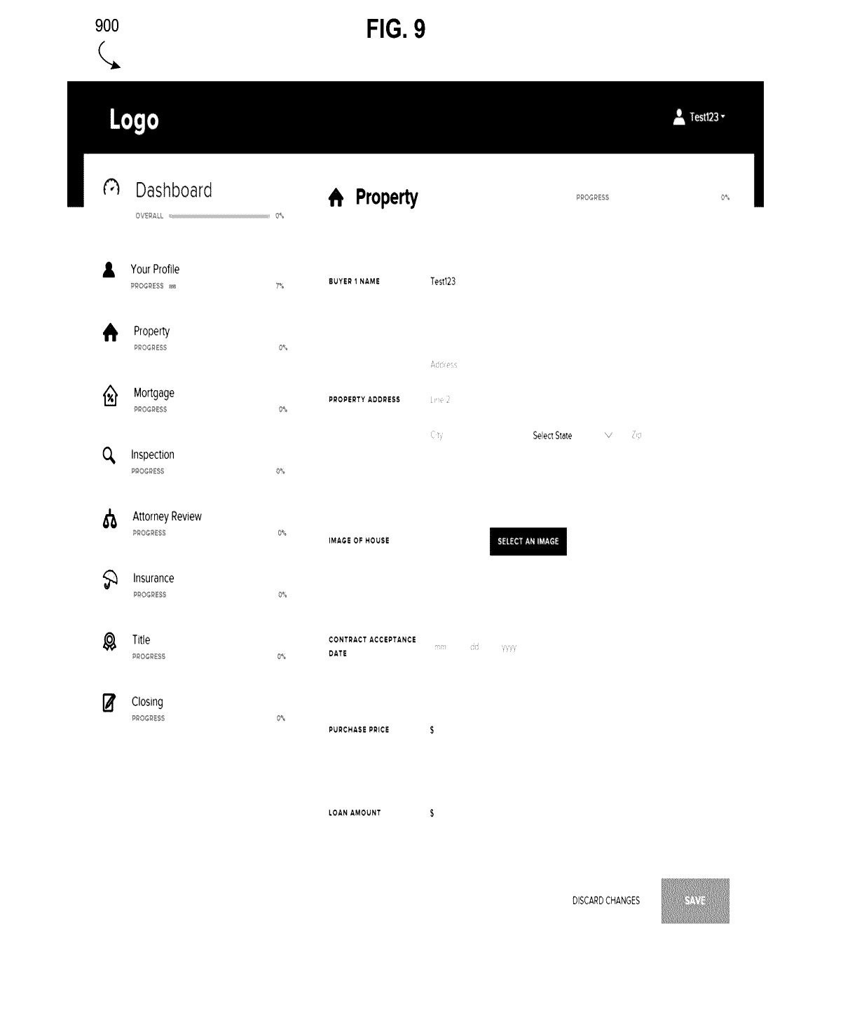

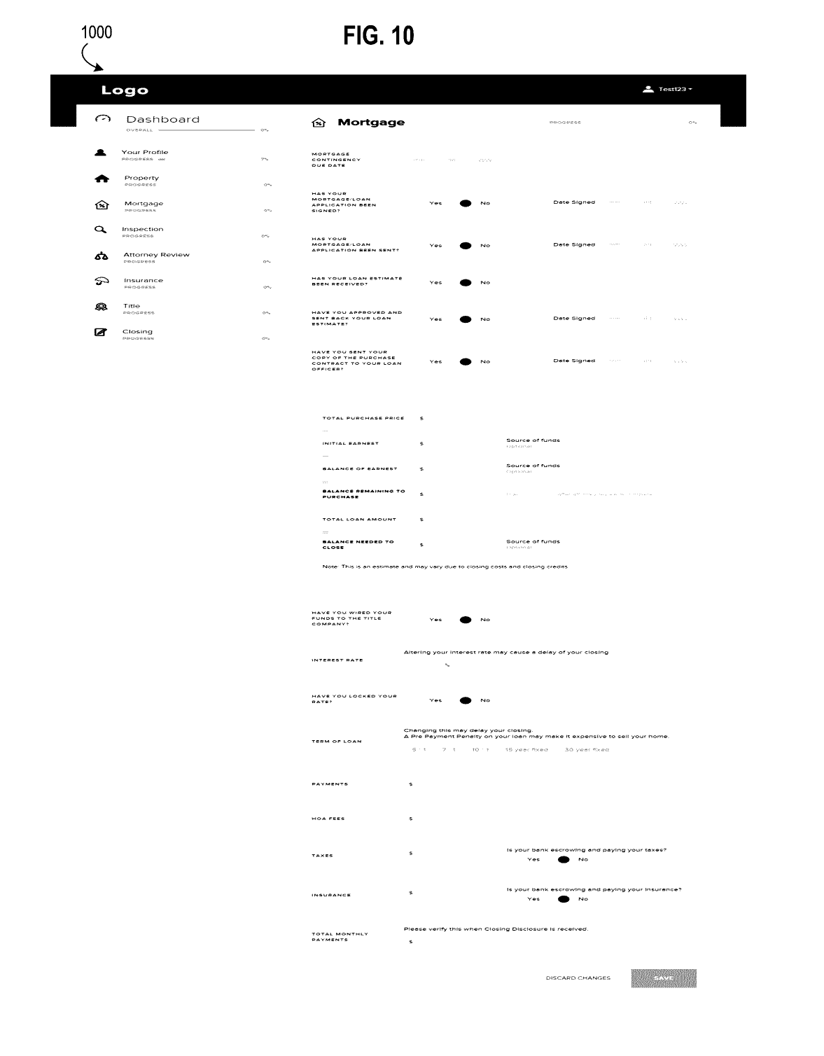

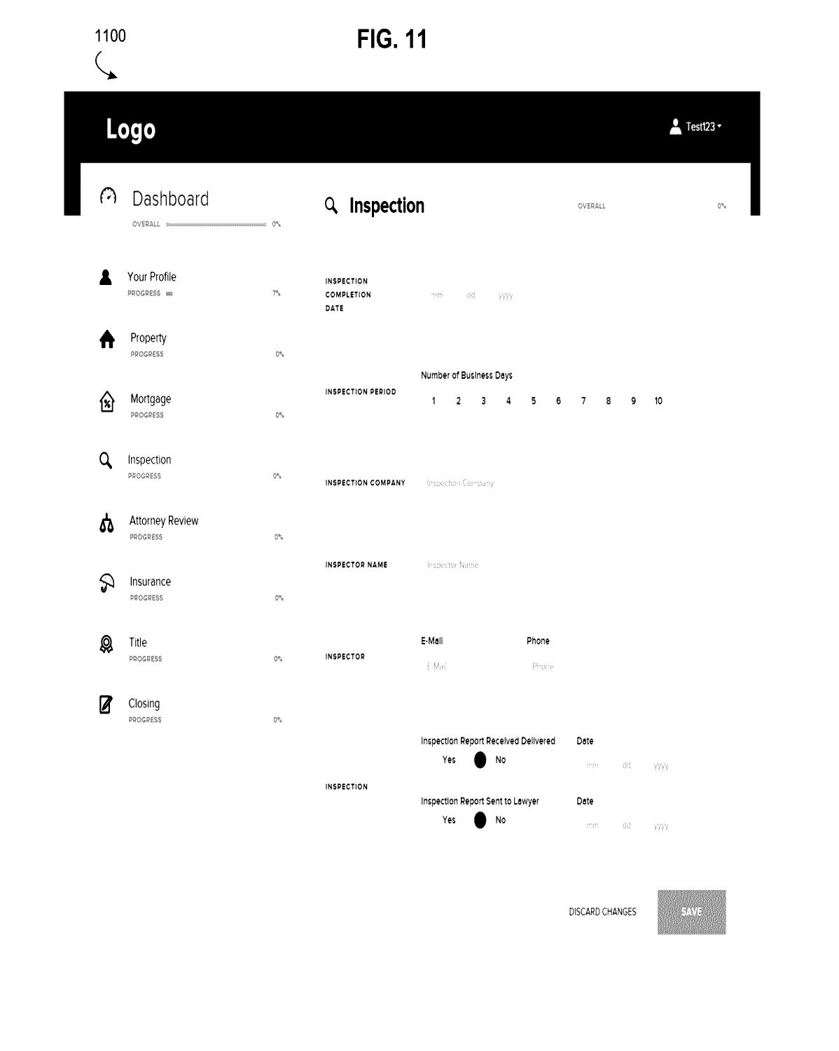

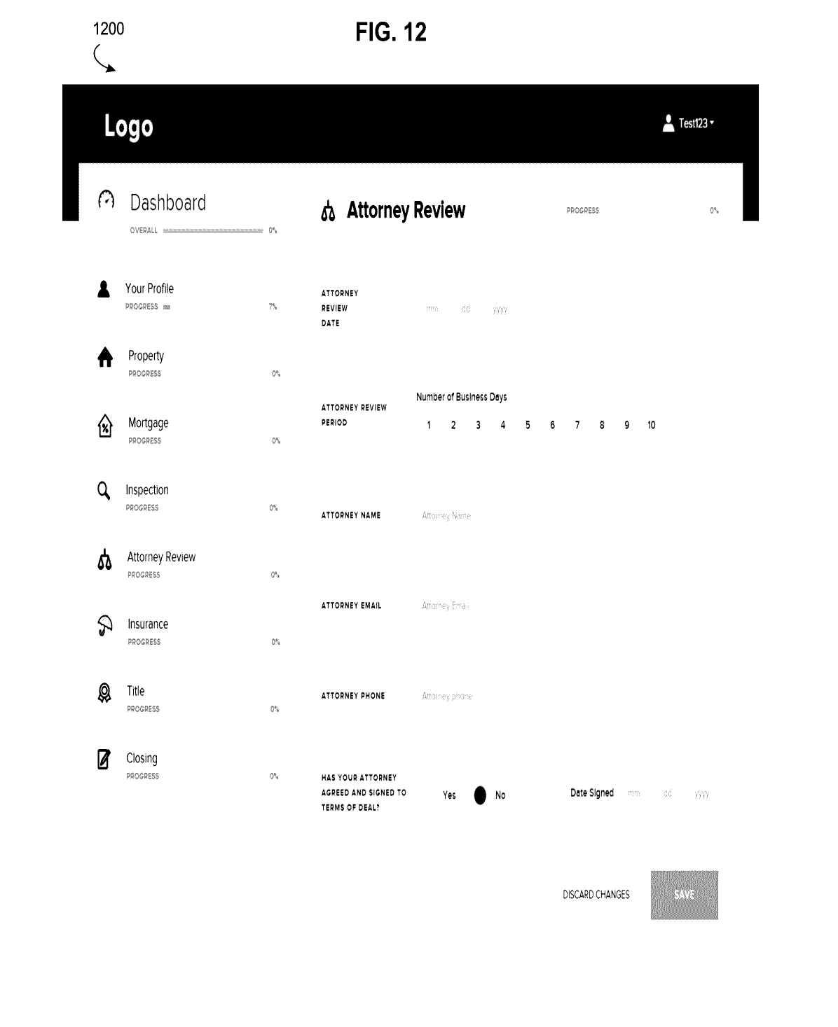

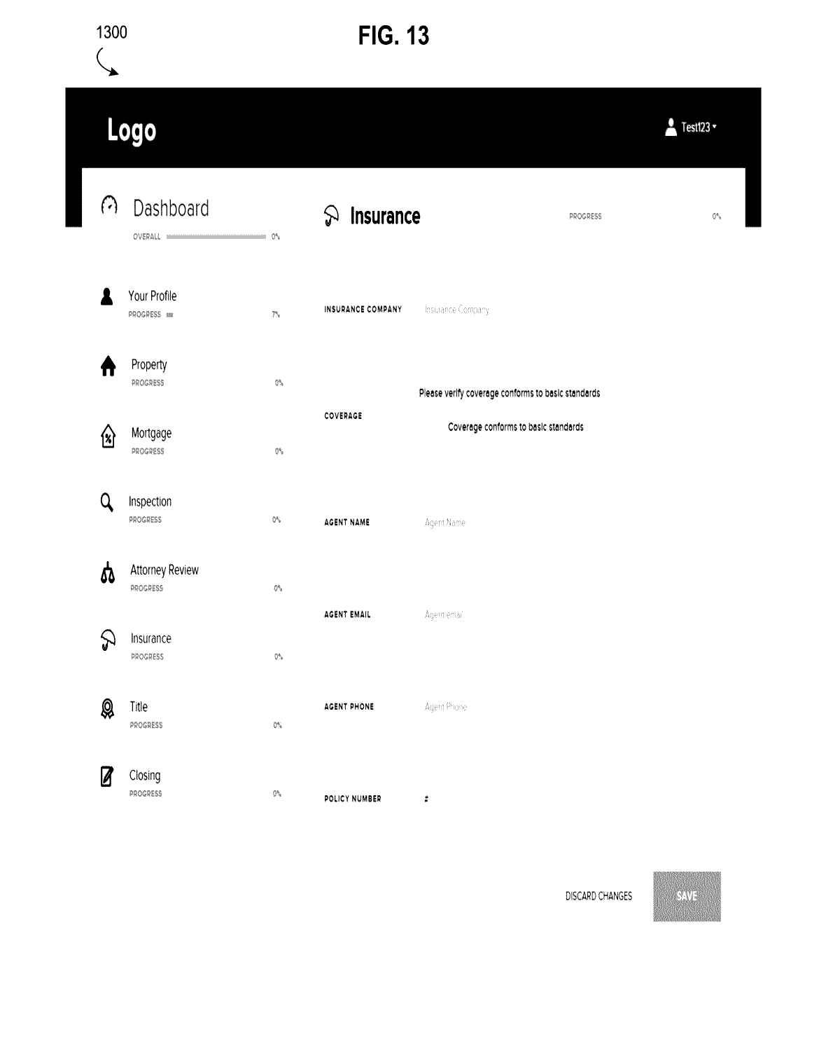

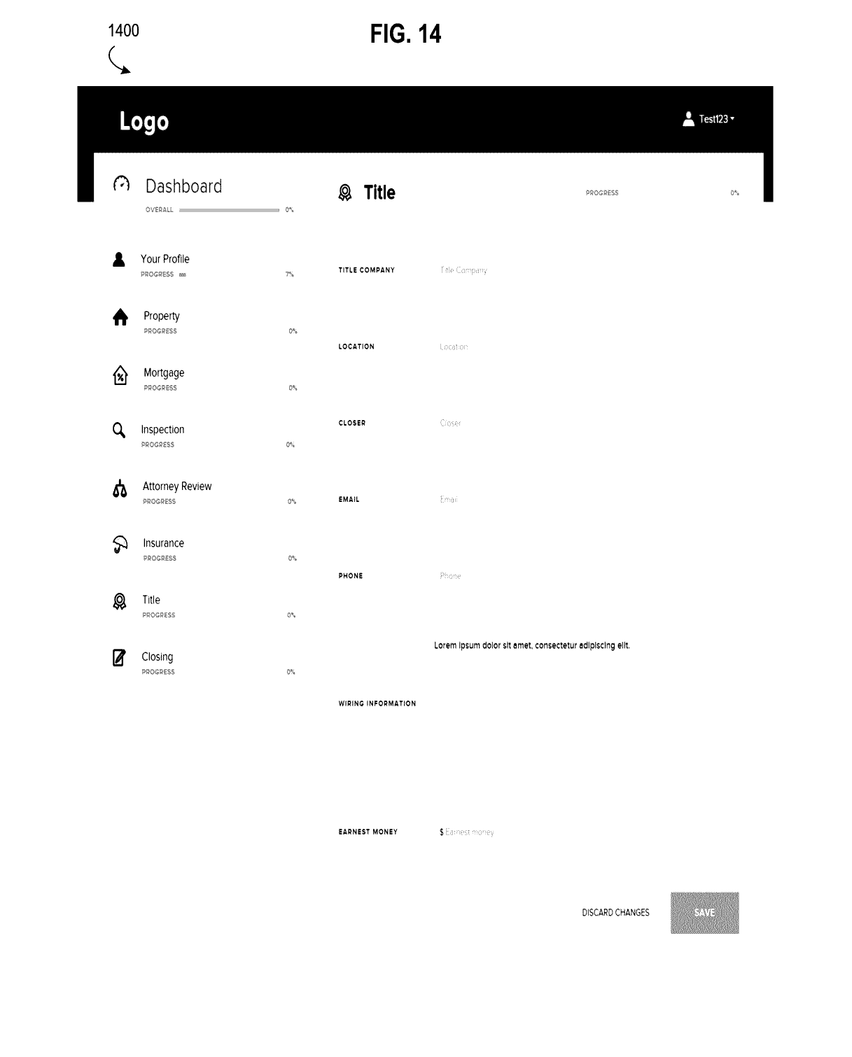

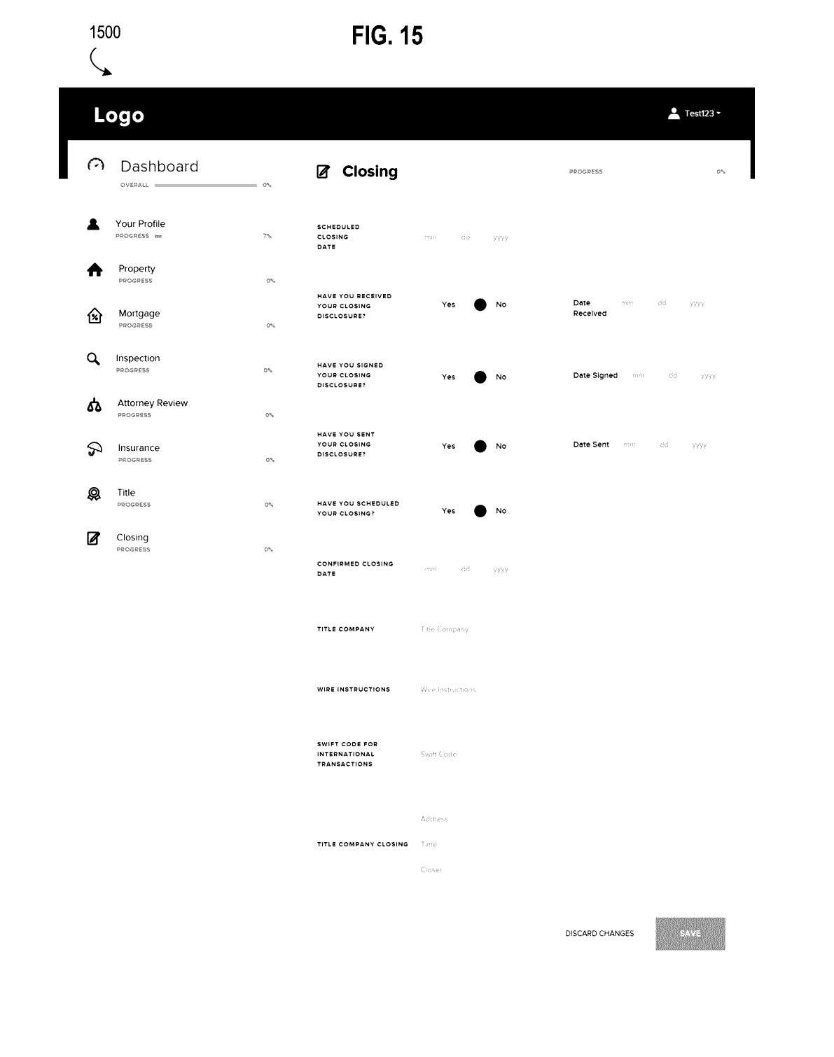

Examples of the one or more user interface screens 212 are shown in FIGS. 6-15. FIG. 6 is an example user interface 600 for the Getting Started screen of the contract-to-close dashboard 120. This user interface 600 may be configured to display and/or solicit authentication information for the one or more parties associated with a real estate transaction. FIG. 7 is an example user interface 700 for the Dashboard screen of the contract-to-close dashboard 120. This user interface 700 may be configured to display summary information related to the one or more buyers, the property, and/or current status of the real estate workflow. FIG. 8 is an example user interface 800 of the Your Profile screen of the contract-to-close dashboard 120. This user interface 800 may be configured to display and/or solicit information associated with the one or more buyers associated with the real estate transaction, as described above in relation to the buyer info database 262. FIG. 9 is an example user interface 900 of the Property screen of the contract-to-close dashboard 120. This user interface 900 may be configured to display and/or solicit information associated with the property associated with the real estate transaction, as described above in relation to the property info database 264. FIG. 10 is an example user interface 1000 of the Mortgage screen of the contract-to-close dashboard 120. This user interface 1000 may be configured to display and/or solicit information related to the process of acquiring a mortgage and/or loan on the property, as described above in relation to the mortgage info database 268. FIG. 11 is an example user interface 1100 of the Inspection screen of the contract-to-close dashboard 120. This user interface 1100 may be configured to display and/or solicit information related to the process of obtaining an inspection on the property, as described above in relation to the inspection info database 270. FIG. 12 is an example user interface 1200 of the Attorney Review screen of the contract-to-close dashboard 120. This user interface 1200 may be configured to display and/or solicit information related to the process of obtaining an attorney review, as described above in relation to the attorney review info database 272. FIG. 13 is an example user interface 1300 of the Insurance screen of the contract-to-close dashboard 120. This user interface 1300 may be configured to display and/or solicit information related to the process of obtaining insurance coverage, as described above in relation to the insurance info database 274. FIG. 14 is an example user interface 1400 of the Title screen of the contract-to-close dashboard 120. This user interface 1400 may be configured to display and/or solicit information related to obtaining title to the property, as described in relation to the title info database 276. FIG. 15 is an example user interface 1500 of the Closing screen of the contract-to-close dashboard 120. This user interface 1500 may be configured to display and/or solicit information related to closing the property, as described above in relation to the closing info database 278.

Example implementations of the initiation module 214, the contract-to-close workflow execution engine 220, and the recommendation engine 240 will be described in further detail below.

Referring now to FIG. 3, a flowchart 300 of example steps for initiating a new contract-to-close workflow for a new real estate transaction is shown. The various components of the real estate workflow management engine 110 may be used to perform these method steps. In this example, in step 302, the real estate workflow management engine 110 may enable a buyer to login via the contract-to-close dashboard 120. For instance, the real estate workflow management engine 110 may provide the user interface 600 to the contract-to-close dashboard 120, where the user interface 600 may be configured to solicit information associated with the buyer. For instance, the buyer may be asked to provide a name and the one or more other parties associated with the real estate transaction. Additionally, the buyer may be asked to specify a username and password to be used for subsequent logins via the contract-to-close dashboard 120. Upon receiving a request to login, the initiation module 214 of the real estate workflow management engine 110 may be configured to, in operation, store the information provided by the buyer in the buyer info database 262.

It will be appreciated that the process described above may be configured such that the real estate workflow management engine 110 may solicit similar information from the one or more other parties associated with the real estate transaction. Further, it will be appreciated that the authentication information provided by the one or more parties may be store in the buyer info database 262, such that the real estate workflow management engine 110 may verify login subsequent login attempts by the one or more parties via the contract-to-close dashboard. For example, the real estate workflow management engine 110 may, upon a subsequent login attempt, determine whether there is a record in the buyer info database 262 with a matching username and password combination. Login attempts with mismatched username and password combinations (e.g., no record found, incorrect username, incorrect password, etc.) will be denied. In some examples, the real estate workflow management engine 110 may provide additional authentication measures, such as Completely Automated Public Turing Test to tell Computers and Humans Apart (CAPTCHA) codes, and the like.

Upon successful login, whether an initial attempt or a subsequent attempt, the real estate workflow management engine 110 may direct the user (e.g., the one or more parties associated with the real estate transaction) to user interface 700.

In step 304, the real estate workflow management engine 110 may solicit information from the buyer to populate the buyer info database 262. For instance, the real estate workflow management engine 110 may provide the user interface 800 to the contract-to-close dashboard 120, where the user interface 800 may be configured to solicit information associated with the buyer. The initiation module 214 of the real estate workflow management engine 110 may receive and store this information in the buyer info database 262. In some examples, the real estate workflow management engine 110 may also solicit some or all information from the buyer for information associated with the one or more other parties associated with the real estate transaction. Additionally or alternatively, the real estate workflow management engine 110 may solicit some or all information associated with the one or more parties directly from the one or more parties.

In step 306, the real estate workflow management engine 110 may solicit information from the buyer to populate the property info database 264. For instance, the real estate workflow management engine 110 may provide the user interface 900 to the contract-to-close dashboard 120, where the user interface 900 may be configured to solicit information associated with a property associated with the real estate transaction. The initiation module 214 of the real estate workflow management engine 110 may receive and store this information in the property info database 264. In some examples, the real estate workflow management engine 110 may solicit some or all information associated with the property from the one or more parties associated with the real estate transaction. For instance, the real estate workflow management engine 110 may solicit some or all information associated with the property from a real estate agent associated with the real estate transaction.

In step 308, the real estate workflow management engine 110 may generate a default contract-to-close workflow for the buyer. A contract-to-close workflow may include one or more phases, e.g., a mortgage phase, an inspection phase, an attorney review phase, an insurance phase, a title phase, a closing phase, etc. A default contract-to-close workflow may be a contract-to-close workflow that is common to one or more buyers. As such, the real estate workflow management engine 110 may generate the same default contract-to-close workflow for one or more buyers for one or more properties. Thus, the default contract-to-close workflow may not vary based on the information associated with the buyer and/or property as stored in the buyer info database 262 and/or the property info database 264. To illustrate, a default contract-to-close workflow may be based on a standard 30-day period (or some other constant time period) between the contract acceptance date and the closing date. The default contract-to-close workflow may accordingly specify deadlines for the one or more phases, such that the contract-to-close workflow can be completed within the 30-day period.

In some examples, the real estate workflow management engine 110 may determine an order in which the one or more phases of the contract-to-close workflow may or must be completed. For instance, the real estate workflow management engine 110 may determine that the one or more phases (or steps within the one or more phases) of the contract-to-close workflow may be completed in parallel or must be completed sequentially. In another example, the real estate workflow management engine 110 may determine that a first portion of the one or more phases of the contract-to-close workflow may be completed in parallel, but that a second portion of the one or more phases of the contract-to-close workflow must be completed sequentially. To illustrate, the real estate workflow management engine 110 may prescribe that the mortgage phase, inspection phase, the attorney review phase, and the insurance phase may be completed in parallel, whereas the title phase and the closing phase must be completed sequentially, such that the title phase must be completed before the closing phases can be commenced.

Additionally or alternatively, the real estate workflow management engine 110 may associate one or more deadlines with the one or more phases of the contract-to-close workflow. In some examples, the real estate workflow management engine 110 may also provide deadlines for one or more steps within the one or more phases. The deadline may be calculated based on a specific date (e.g., a closing date of xx/yy/zzzz, etc.), or as a relative time (e.g., a closing date of 45 days after the contract date, a closing date of 60 days after the contract date, a closing date of 90 days after the contract date, etc.).

Additionally or alternatively, the real estate workflow management engine 110 may specify a total time for the contract-to-close workflow. As such, the real estate workflow management engine 110 may require that all phases of the contract-to-close workflow must be completed within the total time. The total time may be expressed as a specific date (e.g., a closing date of xx/yy/zzzz, etc.), or as a relative time (e.g., a closing date of 45 days after the initiation of the contract-to-close workflow, a closing date of 60 days after the contract acceptance date, a closing date of 90 days after the contract acceptance date, etc.). In some examples, the total time for the contract-to-close workflow may be used by the real estate workflow management engine 110 to automatically determine whether a real estate transaction is unsuccessful based on the total time. For instance, where the total time for a contract-to-close workflow has expired (e.g., the specific date has passed, closing phase has not been completed within 45 days of the contract acceptance date, etc.), the real estate workflow management engine 110 may consider a contract-to-close workflow and/or real estate transaction to be unsuccessful. In some examples, the real estate workflow management engine 110 may update the status of the real estate transaction in the contract-to-close workflow status database 266 of the data store 260 (e.g., ‘Failed’, ‘Unsuccessful’, etc.). In some instances, the real estate workflow management engine 110 may also store the reason for the failure (e.g., incomplete mortgage phase, incomplete inspection phase, incomplete attorney review phase, incomplete insurance phase, incomplete title phase, incomplete closing phase, etc.). Further, the real estate workflow management engine 110 may communicate with one or more of the external systems 140 to determine a more detailed reason for the failure (e.g., communicate with one or more banks to determine reason for mortgage/loan rejection, one or more insurance companies to determine reason for insurance coverage rejection, etc.). For instance, the real estate workflow management engine 110 may update the property info database 264 and the contract-to-close workflow status database 266 to reflect the updated status. Additionally or alternatively, the real estate workflow management engine 110 may update the user interfaces such that none of the parties associated with the real estate transaction are able to update information associated with the unsuccessful real estate transaction.

In some cases, the real estate workflow management engine 110 may store the default contract-to-close workflow in the contract-to-close workflow status database 266. In some examples, the real estate workflow management engine 110 may store information associated with each of the one or more phases of the default contract-to-close workflow in the appropriate database within the contract-to-close workflow status database 266. For instance, the real estate workflow management engine 110 may store information associated with the mortgage phase in the mortgage info database 268, information associated with the inspection phase in the inspection info database 270, information associated with the attorney review phase in the attorney review info database 272, information associated with the insurance phase in the insurance info database 274, information associated with the title phase in the title info database 276, and information associated with the closing phase in the closing info database 278. The information associated with the one or more phases may include, as described above, information relating to the order of the phases, deadlines of the phases, etc.

In step 310, the real estate workflow management engine 110 may adjust the contract-to-close workflow based on one or more factors. The one or more factors may include, but are not limited to, one or more attributes of the buyer's profile (e.g., information associated with the buyer as stored in the buyer info database 262, information obtained from one or more external systems 140, etc.), one or more attributes of the property's profile (e.g., information associated with the property as stored in the property info database 264, information obtained from one or more external systems 140, etc.), and historical data.

Further, the real estate workflow management engine 110 may communicate with one or more external systems 140 to gather additional information about the buyer and/or the property. For instance, the real estate workflow management engine 110 may provide information associated with the buyer and/or information associated with the property to one or more external systems 140 to gather additional information associated with the buyer and/or the property. In some cases, the real estate workflow management engine 110 may communicate with the one or more external systems 140 via one or more Application Program Interfaces (APIs) to which the real estate workflow management engine 110 may provide information associated with the buyer and/or information associated with the property and may expect output including additional information about the buyer and/or the property. The real estate workflow management engine 110 may support receiving the additional information in various formats, including, but not limited to, JSON, XML, YAML, CSV, etc. To illustrate, the real estate workflow management engine 110 may communicate with a credit reporting agency system to obtain a credit report for the buyer. In another example, the real estate workflow management engine 110 may communicate with a consumer data analytics agency system (e.g., purchasing history, purchasing habits/behavior, etc.). In yet another example, the real estate workflow management engine 110 may communicate with a banking system and/or a credit card provider system to obtain financial history (e.g., income information, debt information, wealth information, mortgage information, etc.). In yet another example, the real estate workflow management engine 110 may communicate with a government system (e.g., a city bureau system, etc.) and/or a third-party system that maintains property records to obtain information about current impediments to the property under contract, including, but not limited to, building code and/or zoning violations against the property, liens against the property, building-related court actions against the property, etc. In these examples, to obtain additional information about the buyer, the real estate workflow management engine 110 may provide one or more input parameters, such as the buyer's name, contact information, social security number, etc. In these examples, to obtain additional information about the property, the real estate workflow management engine 110 may provide one or more input parameters, such as the property's address, image of property, etc.

In some examples, the real estate workflow management engine 110 may store additional information associated with the buyer obtained from the one or more external systems 140 in the buyer info database 262. Similarly, the real estate workflow management engine 110 may store additional information associated with the property obtained from the one or more external systems 140 in the property info database.

Additionally or alternatively, the real estate workflow management engine 110 may analyze historical data to adjust the contract-to-close workflow. In some cases, the historical data may include information associated with other contract-to-close workflows managed or being managed through the real estate workflow management engine 110 (e.g., prior successful real estate transactions, prior unsuccessful real estate transactions, pending real estate transactions, etc.). As such, historical data may include information associated with real estate transactions involving other buyers and/or other properties.

The recommendation engine 240 of the real estate workflow management engine 110 may provide recommendations to adjust the contract-to-close workflow based on one or more attributes of the buyer's profile, one or more attributes of a property's profile, historical data, and any combination thereof. Example implementations of the recommendation engine 240 will be described in further detail below.

Referring now to FIG. 4, an example implementation of a recommendation engine 240 is shown. In particular, the block diagram 400 shows an example implementation of using the recommendation engine 240 to provide predictive analytics. As such, the recommendation engine 240 may use this example method to provide recommendations to adjust the contract-to-close workflow based on the one or more factors discussed above. In particular, the recommendation engine 240 may use predictive analytics techniques that learn from accumulated transaction history maintained by the real estate workflow management engine 110. For instance, the recommendation engine 240 may use predictive analytics techniques to analyze information associated with previous contract-to-close workflows managed by the real estate workflow management engine 110 to make predictions about the buyer's current contract-to-close workflow.

In this example, the rule learning component 244 of the recommendation engine 240 may be configured to, in operation, retrieve historical training data sets 402. The historical training data sets 402 may include one or more data points representative of some or all previous contract-to-close workflows managed via the real estate workflow management engine 110. The rule learning component 244 may repeat the retrieval of the historical training data sets 402 on a continuous or intermittent (e.g., periodic) basis, and/or on an on-demand basis (e.g., in response to the completion of one or more contract-to-close workflows, etc.). The rule learning component 244 may also be configured to, in operation, analyze the retrieved historical training data sets 402 in order to detect patterns in the data. As such, the rule learning component 244 may generate one or more rules to reflect the detected patterns.

The data points included in the historical training data sets 402 may include information associated with some or all previous contract-to-close workflows managed via the real estate workflow management engine 110. For example, the information may include, but is not limited to, buyer attributes, property attributes, and/or status attributes associated with the previous contract-to-close workflow. In some examples, the previous contract-to-close workflows may be associated with some or all of the same buyers as the current transaction. The historical training data sets 402 thus may include information associated with one or more previous contract-to-close workflows, where each previous contract-to-close workflow is associated with one or more labels. For instance, a first contract-to-close workflow may have labels for its final status (e.g., Successful, Unsuccessful), one or more buyer attributes (e.g., buyer's credit score, buyer's debt-to-income ratio, buyer's age, etc.), and/or one or more property attributes (e.g., property's location, property's purchase price, property's known violations, etc.). The one or more labels associated with the one or more previous contract-to-close workflows may be used by the rule learning component 244 to generate classifiers and/or rules, as will be described in further detail below.

This information may be collected on an ongoing basis by the real estate workflow management engine 110. For instance, the real estate workflow management engine 110 may collect this information during the pendency of the contract-to-close workflow, and ensure that the current status of the workflow is reflected upon completion (e.g., successful completion, unsuccessful completion) of the contract-to-close workflow. In some instances, the historical information may be archived and stored in the contract-to-close workflow status database 266. As such, the real estate workflow management engine 110 may store historical information associated with the mortgage phase in the mortgage info database 268, information associated with the inspection phase in the inspection info database 270, information associated with the attorney review phase in the attorney review info database 272, information associated with the insurance phase in the insurance info database 274, information associated with the title phase in the title info database 276, and information associated with the closing phase in the closing info database 278. Further, in some examples, the historical information stored in the contract-to-close workflow status database 266 may be archived in order to optimize consumption of storage space in the real estate workflow management engine 110.

The rule learning component 244 of the recommendation engine 240 may implement one or more predictive analytics techniques, such as supervised machine learning algorithms, unsupervised machine learning algorithms, and pattern recognition algorithms that are currently well-known in the art, to recognize patterns in the historical training data sets 402. Examples of supervised learning techniques may include Bayesian classifiers, decision trees, neural networks, regression (e.g., linear, Bayesian linear, logistic, etc.), and/or support vector machines (SVMs). Examples of unsupervised learning techniques may include clustering algorithms, such as canopy, fuzzy k-means, k-means, and Dirichlet. The rule learning component 244 may implement one or more of these techniques based on various factors including, but not limited to, speed of training, speed of prediction, accuracy of prediction, etc.

In some examples, the rule learning component 244 may create predictive models based on the historical training data sets 402. For instance, the rule learning component 244 may create predictive models of some or all of the previous contract-to-close workflows included in the historical training data sets 402 by selecting two or more labels associated with previous contract-to-close workflows. Based on the predictive models, the rule learning component 244 may use one or more of the supervised learning techniques create classifiers and identify patterns in the data. For example, the rule learning component 244 may implement a linear regression algorithm to separate previous successful contract-to-close workflows from previous unsuccessful contract-to-close workflows based on closing period (e.g., 45 days after contract date, 60 days after contract date, 90 days after contract date, etc.), the buyer's credit score, and property's purchase price. In this example, the rule learning component 244 may assume that classes (e.g., successful workflows, unsuccessful workflows, etc.) may be separated by a straight line or a higher dimension equivalent. In another example, the rule learning component 244 may implement a logistic regression algorithm to separate previous successful contract-to-close workflows from previous unsuccessful contract-to-close workflows based on closing period, all buyer attributes, and all property attributes. In this example, the rule learning component 244 may assume that classes may be separated by an S-shaped curve or a higher dimension equivalent. It will be appreciated that the other predictive analytics techniques described above may be similarly implemented by the rule learning component 244.

Further, the rule learning component 244 may use predictive analytics to generate (e.g., create, modify, delete, etc.) rules based on the determined patterns. The generated rules may be stored in the rules repository 242, and/or other non-transitory computer-readable medium of the real estate workflow management engine 110. An example rule may be an association between a class (e.g., successful workflows, unsuccessful workflows) and one or more labels, such as one or more buyer attributes, and one or more properties. For instance, a rule may provide that a buyer with a credit score below a credit score threshold value purchasing a property with a purchase price above a purchase price threshold value is more likely to be associated with a successful contract-to-close workflow where the closing period is 60 days. In another example, a rule may provide that a property with two or more existing violations is more likely to be associated with a successful contract-to-close workflow where the closing period is 60 days. In yet another example, a rule may provide that a buyer with a credit score above a credit score threshold value and a debt-to-income ratio below a debt-to-income threshold value purchasing a property with a purchase price below a purchase price threshold value is likely to be associated with a successful contract-to-close workflow where the closing period is 45 days. In another example, a rule may provide that a buyer with more than threshold number of accounts (e.g., as indicated on the buyer's credit report) and more than a threshold number of credit inquiries (e.g., as indicated on the buyer's credit report) is likely to be associated with a successful contract-to-close workflow where the closing period is 90 days. It will be appreciated that the example rules illustrated above are provided by way of example and that other rules may include additional or alternative elements (e.g., buyer attributes, property attributes, etc.). In particular, the rules may vary based on the historical training data sets 402 provided to the rule learning component 244 and/or based on the predictive analytics techniques used by the rule learning component 244.

In some examples, the recommendation engine 240 may include a rules management console 248 to enable administrators of the real estate workflow management engine 110 to create, modify, or delete rules stored in the rules repository 242. The rules management console 248 may be a user interface device that permits the real estate workflow management engine 110 to display information and/or solicit information, as well as accept one or more user interactions with a user. For example, the user interface of the rules management console 248 may permit a user to remove outliers (e.g., remove a previous contract-to-close workflow from consideration by the rule learning component 244) from the historical training data sets 402 and modify the rules stored in the rules repository 242 accordingly. In another example, the user interface of the rules management console 248 may permit a user to add a new rule to the rules repository 242. In yet another example, the user interface of the rules management console 248 may permit a user to modify an existing rule in the rules repository, such that the user may add and/or delete an association between a class and a label.

The rule execution component 246 of the recommendation engine 240 may be configured to, in operation, receive current transaction data 404. The currently transaction data 404 may include information associated with the buyer's contract-to-close workflow. For instance, the current transaction data 404 may include one or more buyer attributes, one or more property attributes, and the default contract-to-close workflow generated by the real estate workflow management engine 110. Further, the rule execution component 246 may be configured to, in operation, apply one or more rules stored in the rules repository 242 to the current transaction data 404 in order to generate a prediction 406. The rule execution component 246 may query the rules repository 242 to retrieve rules based on the current transaction data 404. As such, the rules stored in the rules repository 242 may be keyed by classes and/or by labels. For instance, the rule execution component 246 may receive current transaction data 404 for a contract-to-close workflow associated with a buyer with a 705 credit score, a property purchase price of $400,000, and a closing period of 45 days. In this example, the rule execution component 246 may query the rules repository 242 for rules based on a credit score label, a property purchase price label, and a closing period label. The rule execution component 246 may query for rules within a range of a particular label (e.g., within a numerical range of the buyer's credit score and/or the property's purchase price, within a percentage range of the buyer's credit score and/or within the property's purchase price, etc.) or may query for rules having an identical label.

Based on the classes associated with these rules, the rule execution component 246 may determine whether the current contract-to-close workflow is likely to be successful. For instance, for the example current transaction data 404 provided above, the rule execution component 246 may retrieve a rule associating a successful contract-to-close workflow class with a buyer having a credit score above 700, a property with a purchase price below $500,000, and a closing period of 60 days. As such, the rule execution component 426 may provide a prediction 406 that the contract-to-close workflow represented by the current transaction data 404 is likely to be successful. In another example, for the example current transaction data 404 provided above, the rule execution component 246 may instead retrieve a rule associating an unsuccessful contract-to-close workflow class with a buyer having a credit score below 750, a property price above $400,000, and a closing period of 45 days. As such, the rule execution component 426 may provide a prediction 406 that the contract-to-close workflow represented by the current transaction data 404 is likely to be unsuccessful.

In some cases, the prediction 406 provided by the rule execution component 247 may also include a level of confidence. Where an attribute of the current transaction data 404 is within a threshold (e.g., within a numerical range, within a percentage range, etc.) of a label associated with a rule, the rule execution component 247 may indicate that the prediction is based on a lower level of confidence. The rule execution component 246 may indicate that such a prediction 406 (e.g., a prediction that a contract-to-close workflow will be successful) is a risky estimate where one or more labels of the rule are within a threshold of the corresponding attribute of the current transaction data 404.

In cases where the rule execution component 246 determines that the contract-to-close workflow associated with the current transaction data 404 will be unsuccessful, the rule execution component 246 may determine, based on the rules stored in the rules repository 242, adjustments to the contract-to-close workflow. For example, the rule execution component 246 may determine a set of adjustments to the attributes of the current transaction data 404 such that the adjustments cause the rule execution component 246 to generate a prediction 406 that the adjusted contract-to-close workflow will be successful. For instance, the rule execution component 246 may adjust the closing period and predict whether a contract-to-close workflow with the adjusted closing period and the remaining attributes of the current transaction data 404 is likely to succeed. In some cases, the rule execution component 246 may adjust the deadlines for one or more phases of the contract-to-close workflow and/or the order of the one or more phases of the contract-to-close workflow to predict whether the adjusted contract-to-close workflow is likely to succeed. For instance, for a property with two or more violations, the rule execution component 246 may adjust the contract-to-close workflow such that the inspection phase is commenced earlier than in the default contract-to-close workflow. In another example, for a buyer with a high debt-to-income ratio, the rule execution component 246 may adjust the contract-to-close workflow such that the mortgage phase is commenced earlier than in the default contract-to-close workflow.

In yet another example involving adjustments to a default workflow, where the buyer's income as a trust beneficiary accounts for more than 50% of the buyer's annual income, the rule execution component 246 may adjust the contract-to-close workflow such that the mortgage phase is commenced earlier than in the default contract-to-close workflow. As such, the rule execution component 246 may advantageously adjust the contract-to-close workflow such that the more risky phases of the contract-to-close workflow are prioritized. The rule execution component 246 may continue making adjustments to the contract-to-close workflow until the adjusted contract-to-close workflow is predicted to be successful according to the rules stored in the rules repository 242.

In another example involving adjustments to a default workflow to improve the likelihood of success in that the buyer and seller will reach the closing table and see a successful transfer of the property the subject of a real estate transaction, the phases of the workflow may be considered and each associated with one or more deadlines (e.g., due dates). The workflow management engine may generate one or more of the aforementioned. Subsequently, a recommendation engine may adjust the workflow based on rules. Some examples of rules include the preceding rule regarding a portion of a buyer's income attributed to trust beneficiary proceeds.

Even in cases were the rule execution component 246 determines that the contract-to-close workflow will be successful, the rule execution component 246 may generate one or more recommendations for the buyer. For example, the rule execution component 246 may, based on the rules stored in the rules repository 242, determine that the buyer needs to adjust spending behavior for a particular number of days such that the buyer's score remains within the threshold defined by the rule. In another example, where the rule execution component 246 makes a risky prediction that the contract-to-close workflow is likely to be successful, the rule execution component 246 may recommend that the primary buyer add a co-buyer to the transaction to increase the likelihood that the contract-to-close workflow will be successful.

It will be appreciated that the example method illustrated in FIG. 4 is shown by way of example and that other methods of providing predictions and determining adjustments to a contract-to-close workflow may include additional or alternative steps, components, modules, sub-systems, and so forth.

In some examples, the recommendation engine 240 may communicate with one or more external systems 170 to receive a prediction 406 and/or to determine adjustments to the contract-to-close workflow. For instance, upon retrieving a historical training data set 402, the rule learning component 244 may communicate with an external system 170 to train a model based on the historical training data set 402. The external system 170 may create predictive models based on the historical training data sets 402 submitted by the rule learning component 244.

The external system may be a commercially-available predictive analytics API including, but not limited to, GOOGLE Prediction API, Big ML, MICROSOFT AZURE Machine Learning, BLUE YONDER, GraphLab, SWIFT API, PredictionIO, Logical Glue, etc. The API may provide Simple Object Access Protocol (SOAP) and/or Representational Site Transfer (REST) services, whereby the API exposes one or more remote calls to its consumers (e.g., the recommendation engine 240). One or more of the aforementioned are described in non-patent literature (NPL) cited in an Information Disclosure Statement (IDS) concurrently filed with this application, copies of which are enclosed with the IDS, and all of the NPL (including NPL#1, #2, #3, and #4) are herein incorporated by reference in their entireties. For instance, one commercially-available predictive analytics API exposes services to add data to a new model for training, to add or update data to a trained model, to get a list of available predictive models, to get a training status of a model, to delete a trained model, to get a prediction, to get a prediction using a specific trained model, to get a prediction using a specific algorithm (e.g., supervised, unsupervised, etc.), and so forth.

The rule learning component 244 may provide the external system 170 with access to the historical training data set 402 by, for example, submitting a comma-separated (CSV) file. In another example, the rule learning component 244 may embed the historical training data set 402 in the HTTP (or HTTPS) request to the API. In another example, the rule learning component 244 may grant the external system 170 limited access to the real estate workflow management engine 110, such that the external system 170 is able to retrieve the historical training data set 402 directly from the real estate workflow management engine 110. In another example, the rule learning component 244 may store the historical training data sets 402 in remote/cloud storage device (e.g., Good Cloud Storage, AMAZON S3, Rackspace Cloud Files, Zetta DataProtect, Box, etc.) outside the real estate workflow management engine 110, such that the external system 170 is able to retrieve the historical training data set 402 from the remote storage device. The rule learning component 244 may be in communication with the external system 170 to add to or update the historical training data set 402. In these examples, the rule learning component 244 may first remove and/or mask any content that may be attributed to the buyer.

The rule execution component 246 may access the predictive models created by the external system 170 to receive a prediction 406 on the likelihood of success of a contract-to-close workflow (e.g., based on the current transaction data 404) and/or receive adjustments to the contract-to-close workflow to increase its likelihood of success. In examples where the rule learning component 244 submits multiple historical training data sets 402 to the external system 170, or in examples where the external system 170 creates multiple predictive models based on the historical training data sets 402, each model may have a unique identifier. As such, the rule execution component 246 may elect to receive a prediction 406 and/or adjustments from a particular model created by external system 170 by specifying the unique identifier associated with the model in the request. It will be appreciated that the rule execution component 246 may make multiple calls to the external system 170, for example, when the prediction is that the contract-to-close workflow is likely to be unsuccessful.

In these examples, the recommendation engine 240 may store the information associated with the adjusted contract-to-close workflow in the contract-to-close workflow status database. For instance, the recommendation engine 240 may store information associated with the adjusted mortgage phase in the mortgage info database 268, information associated with the adjusted inspection phase in the inspection info database 270, information associated with the adjusted attorney review phase in the attorney review info database 272, information associated with the adjusted insurance phase in the insurance info database 274, information associated with the adjusted title phase in the title info database 276, and information associated with the adjusted closing phase in the closing info database 278. The information associated with the one or more adjusted phases may include, as described above, information relating to the adjusted order of the phases, adjusted deadlines of the phases, etc. The recommendation engine 240 may also store other adjustments to the contract-to-close workflow (e.g., an adjusted closing period) in the contract-to-close workflow status database 266. As such, the contract-to-close workflow status database 266 may include a primary table wherein information pertaining to some or all phases of the contract-to-close workflow may be stored. Once the information is stored, the recommendation engine 240 may provide an indication to the contract-to-close workflow execution engine 220 that a new contract-to-close workflow is ready for execution.

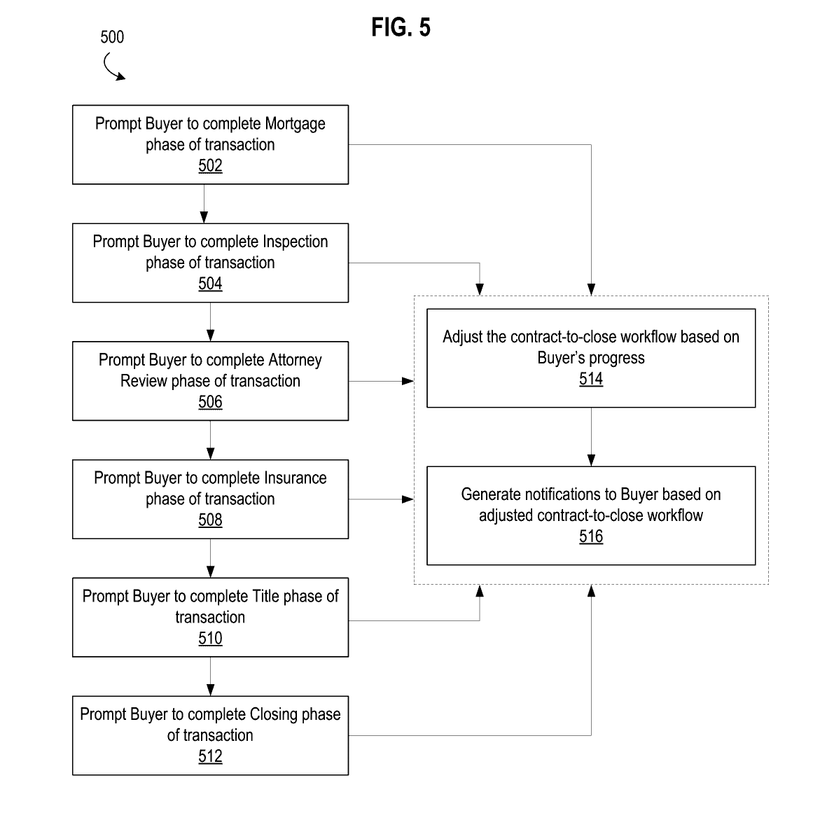

Referring now to FIG. 5, the contract-to-close workflow execution engine 220 of the real estate workflow management engine 110 may be configured to, in operation, guide the buyer and the other parties associated with the real estate transaction from the mortgage phase to the closing phase of the adjusted contract-to-close workflow. As such, the contract-to-close workflow execution engine 220 may prompt the buyer to commence, make progress on, and complete the one or more phases of the contract-to-close workflow based on the adjusted order and/or adjusted deadlines. For instance, the contract-to-close workflow execution engine 220 may display the user interfaces 600, 700, 800, 900, 1000, 1100, 1200, 1300, 1400, and 1500 on the contract-to-close dashboard 150 to display and/or solicit the information related to each phase of the contract-to-close workflow.

In FIG. 5, a flowchart 500 of example steps for executing a contract-to-close workflow for a real estate transaction is shown. The various components of the contract-to-close workflow execution engine 220 may be used to perform these method steps. In this example, in step 502, the mortgage workflow component 222 may provide the user interface 1000 to the contract-to-close dashboard 120, where the user interface 1000 may be configured to solicit information associated with the mortgage phase of the contract-to-close workflow as described above. In step 504, the inspection workflow component 224 may provide the user interface 1100 to the contract-to-close dashboard 120, where the user interface 1100 may be configured to solicit information associated with the inspection phase of the contract-to-close workflow as described above. In step 506, the attorney review workflow component 226 may provide the user interface 1200 to the contract-to-close dashboard 120, where the user interface 1200 may be configured to solicit information associated with the attorney review phase of the contract-to-close workflow as described above. In step 508, the insurance workflow component 228 may provide the user interface 1300 to the contract-to-close dashboard 120, where the user interface 1300 may be configured to solicit information associated with the insurance phase of the contract-to-close workflow as described above. In step 510, the title workflow component 230 may provide the user interface 1400 to the contract-to-close dashboard 120, where the user interface 1400 may be configured to solicit information associated with the title phase of the contract-to-close workflow as described above. In step 512, the closing workflow component 232 may provide the user interface 1500 to the contract-to-close dashboard 120, where the user interface 1500 may be configured to solicit information associated with the closing phase of the contract-to-close workflow as described above.

Information provided through the user interfaces 600, 700, 800, 900, 1000, 1100, 1200, 1300, 1400, and 1500 may be viewable and/or editable in real-time by other parties to the real estate transaction via the contract-to-close dashboard. As such, the current status of each phase of the contract-to-close workflow is readily available to all parties to the real estate transaction. To illustrate, a title company agent may log in to the contract-to-close dashboard to determine whether the property is ready for closing on the scheduled closing date (i.e., whether the one or more phases or prerequisites to transfer of title and closing of transaction have been completed or will be completed within the closing period). In another example, during the attorney review phase, an attorney may provide recommendations to the buyer via the contract-to-close dashboard 150. A buyer logged in to the contract-to-close dashboard may view and/or respond to the recommendations provided by the attorney in real-time. Additionally or alternatively, the contract-to-close workflow execution engine 220 may send push notifications to one or more parties to the real estate transaction in response to a change made to the contract-to-close workflow by one or more parties to the real estate transaction. Examples of push notifications are described in further detail below.

The contract-to-close workflow execution engine 220 may be configured to, in operation, collect additional information related to the contract-to-close workflow from a mobile device 130 via the contract-to-close dashboard 150. For example, during the inspection phase of the contract-to-close workflow, the contract-to-close workflow execution engine 220 may allow the user (e.g., buyer, inspection agent) to submit images taken using a camera installed on the mobile device 130. The user may also request or provide recommendations for responses to the issue reported by the image (e.g., repair/replacement required, inspection by a qualified contractor required, etc.). As such, the buyer and inspection agent may communicate information relating to the inspection phase in real-time via the real estate workflow management engine 110.

It will be appreciated that the steps for executing a contract-to-close workflow as shown in FIG. 5 is shown by way of example and that the order of the steps for executing a contract-to-close workflow may vary based on the adjusted order of the phases of the contract-to-close workflow and/or the adjusted deadlines of the phases of the contract-to-close workflow. Further, other methods of executing a contract-to-close workflow may include additional or alternative components, modules, sub-systems, and so forth.

Further, as shown in step 514, the contract-to-close workflow execution engine 220 may readjust the contract-to-close workflow based on the buyer's progress. As such, the contract-to-close workflow execution engine 220 may communicate the information associated with the contract-to-close workflow to the recommendation engine 240 to receive predictions and/or adjustments the contract-to-close workflow, as described above with reference with FIG. 3. The contract-to-close workflow execution engine 220 may repeat this process on a continuous or intermittent (e.g., periodic), and/or on an on-demand basis (e.g., in response to a completion of one or more phases of the contract-to-close workflow, in response to a missed deadline of one or more phases of the contract-to-close workflow, in response to an upcoming deadline of one or more phases of the contract-to-close workflow, in response to a user login via the contract-to-close dashboard 150, in response to a user input via the contract-to-close dashboard 150, etc.). Where the recommendation engine 240 provides a readjusted contract-to-close workflow based on the buyer's progress, the contract-to-close workflow execution engine 220 may store the information associated with the readjusted contract-to-close workflow in the contract-to-close workflow status database 266. As such, the contract-to-close workflow execution engine 220 may perform the example steps shown in FIG. 5 based on the readjusted contract-to-close workflow.

In some examples, as shown in step 516, the contract-to-close workflow execution engine 220 may generate notifications to the buyer and/or other parties associated with the real estate transaction based on the adjusted contract-to-close workflow. As such, the contract-to-close workflow execution engine 220 may update the user interfaces 600, 700, 800, 900, 1000, 1100, 1200, 1300, 1400, and 1500 to include the generated notifications regarding, for example, upcoming deadlines, missed deadlines, risky phases, etc. In some examples, the contract-to-close workflow execution engine 220 may generate notifications for risky phases on a continuous or intermittent (e.g., periodic) basis.

In examples where the contract-to-close dashboard 150 is accessed via a real estate workflow management engine application installed on a mobile device 130, the contract-to-close workflow execution engine 220 may send push notifications to the mobile device 130. For instance, the contract-to-close workflow execution engine 220 may communicate to the buyer any changes made by parties to the real estate transaction to the contract-to-close workflow via push notifications, such that the buyer may receive notifications of changes made by other parties to the real estate transaction in real-time without being logged into the contract-to-close dashboard 150. As such, the mobile device 130 may be configured to, in operation, alert the user with a message displayed on the mobile device 130 (e.g., home screen, lock screen, status bar, etc.), and may be viewed even when the user is not actively using the real estate workflow management engine application (e.g., application is installed but not running, user is not logged into the application, etc.). In some examples, where the user interacts with the push notification (e.g., taps the notification for more information, etc.), the user may be directed to the real estate workflow management engine application, such that the application may display the notifications via the user interfaces 600, 700, 800, 900, 1000, 1100, 1200, 1300, 1400, and 1500 described above.

In other examples, the contract-to-close workflow execution engine 220 may send push notifications to the buyer to make recommendations. For instance, the contract-to-close workflow execution engine 220 may recommend that the buyer change one or more mortgage loan parameters to increase the likelihood that the mortgage phase of the contract-to-flow workflow will be successfully completed. To illustrate, the rule execution component 246 may recommend that the buyer opt for a Federal Housing Administration (FHA) loan instead of a Jumbo loan where the buyer has a credit score at or below 700.

In other examples, the contract-to-close workflow execution engine 220 may generate location-based notifications. The contract-to-close workflow execution engine 220 may use the GPS functionality (e.g., via a GPS navigation device, a GPS receiver, etc.) of the mobile device 130 to determine the current location of the buyer and/or other parties associated with the real estate transaction. For example, the contract-to-close workflow execution engine 220 may generate notifications to alert a buyer that a service provided required to complete the contract-to-close workflow is nearby. The contract-to-close workflow execution engine 220 may maintain a list (e.g., stored in the data store 260) of service providers (e.g., attorneys, banks, inspectors, insurance companies, title companies, etc.) and their locations. The contract-to-close workflow execution engine 220 may compare the current location of a buyer, as determined by the GPS functionality of the mobile device 130, to the locations of some or all of the service providers in the list. For instance, where the mortgage phase of the contract-to-close workflow has been started and/or has an upcoming deadline, but where the buyer has not designated a bank, the contract-to-close workflow execution engine 220 may compare the current location of the buyer with the locations of the banks in the list. Similarly, where the insurance phase of the contract-to-close workflow has been started and/or has an upcoming deadline, but where the buyer has not designated an insurance company, the contract-to-close workflow execution engine 220 may compare the current location of the buyer with locations of the insurance companies. The comparison may be performed continuously or intermittently (e.g., periodically). As such, when the current location of a buyer is within a predetermined radius of the location of a potential service provider, the contract-to-close workflow execution engine 220 may send push notifications to the mobile device 130. The push notifications may include information about the potential service provider including, but not limited to, the name, address, user reviews, website, etc. In some examples, the contract-to-close workflow execution engine 220 may order and/or select the service providers for which to send push notifications based on factors other than location, such as whether the service provider has prior experience with the real estate workflow management engine 110, industry and/or user ratings, etc. Additionally or alternatively, the contract-to-close workflow execution engine 220 may maintain a list of preferred service providers. As such, in some examples, the contract-to-close workflow execution engine 220 may send push notifications to the mobile device 130 with an indication of whether the nearby service provider is a preferred service provider. In other examples, the contract-to-close workflow execution engine 220 may only send push notifications to the mobile device 130 for nearby preferred service providers.

In some examples, the contract-to-close workflow execution engine 220 may track the number of notifications it has sent to a buyer, seller, and/or other parties associated with the real estate transaction. The contract-to-close workflow execution engine 220 may store this information in the contract-to-close workflow status database 266. Further, in some examples, the recommendation engine 240 may use this information to make adjustments to the contract-to-close workflow, using the methods described above. As such, this information may be included in the historical training data sets 402 consumed by the rule learning component 244 of the recommendation engine 240. For instance, the recommendation engine 240 may use the number of notifications sent to a buyer and/or other parties associated with the real estate transaction as a measure of responsiveness. The number of notifications sent to a buyer and/or other parties associated with the real estate transaction may therefore be a factor in determining predictive models and rules based on the historical training data sets 402. For example, a rule may provide that a buyer who has received more than a first threshold number of notifications is more likely to be associated with a successful contract-to-close workflow where the closing period is 90 days. In another example, a rule may provide that a buyer who has received less than a second threshold number of notifications is more likely to be associated with a successful contract-to-close workflow where the closing period is 30 days.

Since the contract-to-close dashboard 150 may be utilized by the various parties associated with the real estate transaction and on limited-size display screens, the contract-to-close workflow execution engine 220 may arrange the user interfaces 600, 700, 800, 900, 1000, 1100, 1200, 1300, 1400, and 1500 such that they are most suitable for the current user. As such, the contract-to-close dashboard 150 may receive optimized user interfaces 600, 700, 800, 900, 1000, 1100, 1200, 1300, 1400, and 1500 based on factors including, but not limited to, a current user (e.g., buyer, co-buyer, attorney, inspector, insurance agent, title company, etc.), a current location of the current user, a set of permissions associated with the current user, etc. For instance, where the current user is a co-buyer, the contract-to-close workflow execution engine 220 may only display information, solicit information, or prompt the user for activities required to be performed by the co-buyer. In another example, where the current user is an attorney, the contract-to-close workflow execution engine 220 may only display information, solicit information, or prompt the user for activities related to the attorney review phase. In another example, where the current user is an inspection agent, the contract-to-close workflow execution engine 220 may only display information, solicit information, or prompt the user for activities related to the inspection phase.

Additionally or alternatively, in some examples, the users of the contract-to-close dashboard 150 may be associated with a set of permissions. The contract-to-close workflow execution engine 220 may vary (e.g., limit) the information that is viewable and/or editable by a particular user based on the set of permissions associated with the user. Examples of information that may be limited to a particular user may include information associated with the primary buyer (e.g., social security number, credit report, relationship status, aliases, etc.). In these examples, other parties to the transaction may only be given access to necessary information. For instance, an inspection agent may have access to the inspection phase of the contract-to-close dashboard 150. In another example, a closing agent may have access to the dashboard such that the closing agent is able to monitor the status of the contract-to-close workflow. In another example, a co-buyer may have access to all phases of the contract-to-close dashboard 150, but information relating to the primary buyer may be hidden. As such, the contract-to-close workflow execution engine 220 may configure the user interfaces such that this information is not viewable by other parties to the real estate transaction.

In other examples, the contract-to-close workflow execution engine 220 may arrange the user interfaces 600, 700, 800, 900, 1000, 1100, 1200, 1300, 1400, and 1500 according to the adjusted order and/or adjusted deadlines, such that the phases are displayed in chronological order. As such, contract-to-close dashboard 150 may provide optimized user interfaces to the user, such that the more critical (e.g., earliest deadline, most likely to be unsuccessful, etc.) information is displaying more prominently. For instance, the contract-to-close workflow execution engine 220 may arrange the user interfaces 600, 700, 800, 900, 1000, 1100, 1200, 1300, 1400, and 1500 according to priority, such that the more risky phases, or pieces of information associated with the more risky phases, are more prominently displayed (e.g., placed near the top, highlighted, made larger, etc.). In these examples, by optimally rearranging the user interfaces, the contract-to-close workflow execution engine 200 thus improves the display screen of the contract-to-close dashboard 150. The arrangement of user interfaces may additionally or alternatively be performed by the mobile device 130.

In one example involving the preceding optimal arrangement of different pieces of information in a dashboard on a display of limited size on a smartphone, a first piece of information may be associated with a first priority (e.g., top priority) and a second piece of information may be associated with a second priority (e.g., medium priority). Based at least in part on the priority designations, the smartphone may be configured using, inter alia, computer-executable instructions to optimally arrange the first piece of information to be fully visible on the display, but the second piece of information to be only partially visible on the same display. For example, referring to FIG. 9, when a new real estate property transaction is entered into the system for the first time, the contract acceptance date might serve as a benchmark for prioritizing the plurality of user interfaces capable of being visually outputted in a dashboard on a screen of limited screen size (e.g., a 5″ display, a 3.1″ display, an APPLE iPad Mini tablet screen, etc.) on a smartphone. Based on the value in the “contract acceptance date” field, the smartphone may cause to be configured the “property,” “inspection,” and “attorney review” user interfaces to be ranked with higher priorities than the “title” and “closing” user interfaces. As a result, the smartphone causes the higher priority information to be fully visible on the display illustrated in FIG. 9, while the lower priority information to be only partially visible on the display. One example of fully visible may be when the contents of the user interface are expanded instead of displayed as a collapsed tree format. Meanwhile, that information which is only partially visible on the display may be rendered in a collapsed tree format such that the user interface label/identifier may be displayed, but the contents are hidden.

Meanwhile, the workflow management engine may repeatedly (e.g., constantly, at a regular interval, polling, upon an interrupt/trigger being flagged, etc.) monitor the workflow process to dynamically calculate which user interface from among a plurality of user interfaces to show on the display with limited screen size of a user's mobile device. For example, one user of the dashboard (e.g., real estate dashboard) updating the workflow by providing approval for a particular item (e.g., a lender providing a final loan commitment) may cause the workflow management engine to update the status of the workflow. As such, when the system optimally arranges (e.g., automatically relocates) the visual elements/components on the small-size display of the mobile device, that information related to the loan approval process may be truncated/abbreviated because a final loan commitment has been submitted into the system. In other words, the pieces of information displayed on the small size screen may be updated, either dynamically or upon request (i.e., non-dynamically, but upon a subsequent request from the user), to reflect the updated priority associated with each piece of information. At least one benefit of such an optimized small screen device configured to display visual elements in a dashboard is that the screen functions technologically better to display information more pertinent to the user. In some examples, the information displayed be in chronological order. In other examples, the information may be displayed by relevance to the next due date in the workflow.

While the disclosure has been described with respect to specific examples including presently illustrative modes of carrying out the disclosure, a person having ordinary skill in the art, after review of the entirety of the disclosure herein, will appreciate that there are numerous variations and permutations of the above-described systems and techniques that fall within the spirit and scope of the disclosure.

What is claimed is:

1. A mobile device configured to optimize visual output of a dashboard, the mobile device comprising:
a display with a limited screen size;
at least one processor;
a GPS receiver;
an antenna configured to communicate via wireless communication; and
memory storing computer-readable instructions that, when executed by the at least one processor, cause the mobile device to:
send a request from the dashboard via the antenna to a workflow management engine to create a buyer profile, wherein the buyer profile includes a plurality of buyer attributes associated with a buyer, wherein the buyer profile is associated with a new workflow;
send a request from a dashboard via the antenna to the workflow management engine to create a property profile, wherein the property profile is associated with the buyer profile, wherein the property profile includes a plurality of property attributes associated with a property, wherein the property profile is associated with the new workflow;
receive via the antenna from the workflow management engine a plurality of user interfaces based on an adjusted workflow, wherein the adjusted workflow includes a plurality of phases, and wherein the plurality of phases are associated with a set of deadlines; and
displaying on the dashboard via the display the plurality of user interfaces, wherein the plurality of user interfaces includes a first piece of information and a second piece of information, wherein the first piece of information and the second piece of information require more area to be simultaneously displayed on the display than that which is provided by the display with the limited screen size; and
optimally arrange the first piece of information and the second piece of information displayed on the dashboard via the display based, at least in part, on a first priority associated with the first piece of information, a second priority associated with the second piece of information, wherein the first piece of information is fully visible on the display, but the second piece of information is only partially visible on the display.

2. The mobile device of claim 1, wherein the instructions, when executed by the at least one processor, further cause the mobile device to:
receive a first plurality of push notifications via the antenna from the workflow management engine, wherein the first plurality of push notifications are based, at least in part, on the set of deadlines.

3. The mobile device of claim 1, wherein the instructions, when executed by the at least one processor, further cause the mobile device to:
send GPS location data generated by the GPS receiver via the antenna to the workflow management engine; and
receive a second plurality of push notifications via the antenna from the workflow management engine, wherein the second plurality of push notifications are based on a comparison of the GPS location data and location data associated with a plurality of service providers.

4. The mobile device of claim 2, wherein the adjusted workflow is associated with a new real estate transaction, and the optimally arranging of the first piece of information and the second piece of information is further based on a deadline associated with the first piece of information, a deadline associated with the second piece of information, a risk associated with the first piece of information, a risk associated with the second piece of information, or a combination thereof.

5. The mobile device of claim 4, wherein the plurality of phases of the adjusted workflow include a mortgage phase, an inspection phase, an attorney review phase, an insurance phase, a title phase, and a closing phase.

6. A computer-assisted method using predictive analytics comprising:
receiving a request to create a new workflow from a smartphone associated with a buyer via a dashboard;
creating, by an initiation module of a workflow management engine, a buyer profile, wherein the buyer profile includes a plurality of buyer attributes associated with the buyer, wherein the buyer profile is associated with the new workflow, and wherein the plurality of buyer attributes include information received from one or more external systems;
creating, by the initiation module, a property profile, wherein the property profile includes a plurality of property attributes associated with a property, wherein the property profile is associated with the buyer profile, wherein the property profile is associated with the new workflow, and wherein the plurality of property attributes include information received from the one or more external systems;
generating, by the workflow management engine, a default workflow for the buyer, wherein the default workflow includes a first plurality of phases, and wherein the first plurality of phases are associated with a first set of deadlines;
constructing, by a recommendation engine of the workflow management engine, one or more predictive models including a plurality of data points representing previous workflows managed by the workflow management engine, wherein the plurality of data points include a plurality of buyer attributes, a plurality of property attributes, and a plurality of status attributes attributed to some or all of the previous workflows;
generating and storing in a rules repository, by the recommendation engine, a plurality of rules based on the one or more predictive models, wherein the plurality of rules include mappings between a label and a plurality of property attributes, a plurality of property attributes, and a plurality of status attributes; and
generating, by the recommendation engine, an adjusted workflow for the buyer by adjusting the default workflow based on the plurality of rules stored in the rules repository, wherein the adjusted workflow has a higher likelihood of success than the default workflow, wherein the adjusted workflow includes a second plurality of phases, and wherein the second plurality of phases are associated with a second set of deadlines.

7. The computer-assisted method of claim 6, further comprising:
determining, by the recommendation engine, one or more adjustments to the default workflow to generate the adjusted workflow, wherein the one or more adjustments include modifications to an order of the first plurality of phases, modifications to a total time associated with the default workflow, modifications to the first set of deadlines, or a combination thereof.

8. The computer-assisted method of claim 6, further comprising:
executing, by a workflow execution engine of the workflow management engine, adjusted workflow; and
pushing, by the workflow execution engine, to the smartphone associated with the buyer, a first plurality of notifications based, at least in part, on the second set of deadlines.

9. The computer-assisted method of claim 8, further comprising:
optimally arranging, by the workflow execution engine, a first piece of information and a second piece of information to be displayed on the smartphone via on a plurality of user interfaces of the dashboard, based, at least in part, on a priority associated with the first piece of information, a priority associated with the second piece of information, a deadline associated with the first piece of information, a deadline associated with the second piece of information, a risk associated with the first piece of information, a risk associated with the second piece of information, or a combination thereof.

10. The computer-assisted method of claim 8, further comprising:
pushing, by the workflow execution engine, to the smartphone associated with the buyer, a second plurality of notifications based on a comparison of GPS location data generated by a GPS receiver in the smartphone and location data associated with a plurality of service providers.

11. The computer-assisted method of claim 6, wherein the adjusted workflow is associated with a new real estate transaction.

12. The computer-assisted method of claim 12, wherein the second plurality of phases of the adjusted workflow include a mortgage phase, an inspection phase, an attorney review phase, an insurance phase, a title phase, and a closing phase.

13. A workflow management engine, comprising:
at least one processor; and
memory storing computer-readable instructions, that when executed by the at least one processor, cause the workflow management engine to:
receive a request to create a new workflow from a computing device associated with a buyer via a dashboard;
create a buyer profile, wherein the buyer profile includes a plurality of buyer attributes associated with the buyer, and wherein the buyer profile is associated with the new workflow;
create a property profile, wherein the property profile includes a plurality of property attributes associated with a property, wherein the property profile is associated with the buyer profile, and wherein the property profile is associated with the new workflow; and
generate, by the workflow management engine, a default workflow for the buyer, wherein the default workflow includes a first plurality of phases, wherein the first plurality of phases are associated with a first set of deadlines, wherein the default workflow is associated with a new real estate transaction, and wherein the first plurality of phases include a mortgage phase, an inspection phase, an attorney phase, an insurance phase, a title phase, and a closing phase.

14. The workflow management engine of claim 13, wherein the instructions, when executed by the at least one processor, further cause the workflow management engine to:
construct, by a recommendation engine of the workflow management engine, one or more predictive models including a plurality of data points representing previous workflows managed by the workflow management engine, wherein the plurality of data points include a plurality of buyer attributes, a plurality of property attributes, and a plurality of status attributes attributed to some or all of the previous workflows;
generate and store in a rules repository, by the recommendation engine, a plurality of rules based on the one or more predictive models, wherein the plurality of rules include mappings between a label and a plurality of property attributes, a plurality of property attributes, and a plurality of status attributes; and
determine, by the recommendation engine, one or more adjustments to the default workflow to generate an adjusted workflow based on the plurality of rules stored in the rules repository, wherein the adjusted workflow has a higher likelihood of success than the default workflow, wherein the adjusted workflow includes a second plurality of phases, wherein the second plurality of phases is associated with a second set of deadlines, wherein the one or more adjustments include modifications to an order of the first plurality of phases, modifications to a total time associated with the default workflow, modifications to the first set of deadlines, or a combination thereof.

15. The workflow management engine of claim 13, wherein the instructions, when executed by the at least one processor, further cause the workflow management engine to:
execute, by a workflow execution engine of the workflow management engine, adjusted workflow;
generate, by the workflow execution engine, a first plurality of notifications based, at least in part, on the second set of deadlines; and
modify, by the workflow execution engine, a plurality of user interfaces to be displayed on the computing device via the dashboard to include the first plurality of notifications.

16. The workflow management engine of claim 15, wherein the instructions, when executed by the at least one processor, further cause the workflow management engine to:
push, by the workflow execution engine, to a smartphone associated with the buyer, a second plurality of notifications based, at least in part, on the second set of deadlines.

17. The workflow management engine of claim 15, wherein the instructions, when executed by the at least one processor, further cause the workflow management engine to:
push, by the workflow execution engine, to a smartphone associated with the buyer, a third plurality of notifications based on a comparison of GPS location data generated by a GPS receiver in the smartphone and location data associated with a plurality of service providers.

18. The workflow management engine of claim 15, wherein the instructions, when executed by the at least one processor, further cause the workflow management engine to:
optimally arrange, by the workflow execution engine, a first piece of information and a second piece of information associated with the plurality of user interfaces of the dashboard to be displayed on the computing device via the dashboard, based, at least in part, on a priority associated with the first piece of information, a priority associated with the second piece of information, a deadline associated with the first piece of information, a deadline associated with the second piece of information, a risk associated with the first piece of information, a risk associated with the second piece of information, or a combination thereof.

19. The workflow management engine of claim 13, wherein the adjusted workflow is associated with a new real estate transaction.

20. The workflow management engine of claim 19, wherein the second plurality of phases of the adjusted workflow include a mortgage phase, an inspection phase, an attorney review phase, an insurance phase, a title phase, and a closing phase.
